(19) United States
(12) Patent Application Publication
(10) Pub. No.: US 2026/0289263 A1
(43) Pub. Date: Sep. 24, 2026

(54) SYSTEM

(71) Applicant: SoftBank Group Corp., Tokyo (JP)

(72) Inventor: Takayoshi SHIONO, Tokyo (JP)

(73) Assignee: SoftBank Group Corp., Tokyo (JP)

(21) Appl. No.: 19/565,549

(22) Filed: Mar. 13, 2026

(30) Foreign Application Priority Data
Mar. 19, 2025 (JP) 2025-045027

(51) Int. Cl. G06N 3/0475; G10L 13/033; G10L 13/08; G10L 15/26

(52) U.S. Cl. CPC G06N 3/0475; G10L 13/033; G10L 13/08; G10L 15/26

(57) ABSTRACT

A system includes a processor that is configured to provide an interface for receiving information from a user, analyze the received information and evaluate characteristics and an emotional state of the user by using a generative AI model, and generate a prompt for instructing the generative AI model to propose feedback and a personalized action plan to the user.

### CROSS-REFERENCE TO RELATED APPLICATION

This application is based on and claims priority under 35 USC 119 from Japanese Patent Application No. 2025-045027 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, generative AI models have been increasingly used for dialogue systems and support tools. However, conventional systems primarily focus on generating responses based only on the latest user input, and they often fail to accurately consider a user's characteristics, emotional state, and dialogue history in an integrated manner. As a result, such systems may provide feedback or suggested action plans that are not sufficiently tailored to the individual user, which can reduce the effectiveness, reliability, and user trust in the system.

Moreover, existing systems typically lack a mechanism for dynamically prioritizing and routing user information based on an analysis of the user's emotional state. In environments such as customer support, counseling support, or internal corporate communication, important or urgent user messages that reflect a high level of emotional distress may not be promptly directed to an appropriate department or specialized unit. This can lead to delays or inadequacies in responding to users who require timely and suitable support.

Accordingly, there is a need for a system that is capable of: (i) receiving information from a user through an interface, (ii) analyzing the received information by using a generative AI model to evaluate the user's characteristics and emotional state, (iii) generating prompts that instruct the generative AI model to propose feedback and personalized action plans based on not only the current input but also past dialogue history and previously provided information, and (iv) prioritizing and routing user information to an appropriate department according to the result of emotion analysis. The present invention has been made in view of these problems.

### SUMMARY

In order to solve at least part of the above-described problems, an aspect of the present invention provides a system comprising a processor, wherein the processor is configured to provide an interface for receiving information from a user, analyze the received information and evaluate characteristics and an emotional state of the user by using a generative AI model, and generate a prompt for instructing the generative AI model to propose feedback and a personalized action plan to the user.

In one embodiment, the processor is further configured to generate the prompt for instructing the generative AI model to propose the feedback and the action plan based on past dialogue history of the user and information provided by the user. By doing so, the system can cause the generative AI model to output content that is personalized in view of accumulated user-specific context, such as occupation, skills, preferences, and previous concerns, thereby improving the relevance and effectiveness of the feedback and action plans provided to the user.

In another embodiment, the processor is further configured to prioritize processing of the information in consideration of the emotional state of the user and distribute the information to an appropriate department based on a result of emotion analysis. For example, when the emotion analysis indicates that the user is experiencing a high level of stress, anxiety, or other critical emotional conditions, the processor can prioritize such user information in an internal workflow and route it to a specialized support team or department. As a result, the system enables timely and suitable handling of user issues according to emotional urgency, while also leveraging generative AI to provide individualized feedback and action planning.

The term “processor” refers to one or more hardware processing units, such as a central processing unit (CPU), a graphics processing unit (GPU), a digital signal processor (DSP), or any combination thereof, configured to execute instructions to perform the functions described in the present specification.

The term “interface” refers to a hardware and/or software component that enables input of information from a user to the system, including but not limited to graphical user interfaces, command line interfaces, application programming interfaces, touch interfaces, and voice input interfaces.

The term “user” refers to any person or entity that provides information to the system and receives feedback or a personalized action plan from the system.

The term “information from a user” refers to any data provided by the user to the system, including but not limited to text input, voice input, selections made through a graphical user interface, profile data, and responses to questions.

The term “analyze the received information” refers to performing one or more computational processes on the information obtained from the user, such as natural language processing, pattern recognition, feature extraction, classification, or sentiment analysis.

The term “user's characteristics” refers to attributes associated with the user, including but not limited to occupation, skills, preferences, behavioral patterns, demographic information, and previously expressed interests or concerns.

The term “emotional state of the user” refers to a mental or affective condition of the user, such as stress, anxiety, sadness, joy, frustration, or calmness, inferred by the system through analysis of the information provided by the user.

The term “generative AI model” refers to a machine learning model, such as a large language model or other generative neural network, that is configured to generate text or other content in response to input data or prompts.

The term “prompt” refers to a structured input, instruction, or set of instructions provided to the generative AI model, designed to control or guide the content, style, or structure of the output generated by the generative AI model.

The term “feedback” refers to a response generated for the user, including but not limited to explanations, comments, suggestions, reflections, or evaluations, which are intended to address the user's input or situation.

The term “personalized action plan” refers to a sequence of one or more recommended actions, steps, or strategies that are tailored to the specific characteristics, context, and emotional state of the user.

The term “past dialogue history of the user” refers to stored records of previous exchanges between the user and the system, including past user inputs, system responses, and associated metadata such as timestamps or context tags.

The term “information provided by the user” refers to data explicitly supplied by the user at any time, including initial registration information, profile updates, questionnaire answers, and ad hoc input during dialogues.

The term “prioritize processing of the information” refers to controlling the order, speed, or resource allocation of processing operations applied to user information based on predetermined criteria, such as the user's emotional state or urgency level.

The term “emotion analysis” refers to a computational process that estimates or classifies the emotional state of the user from the received information, using techniques such as natural language processing, sentiment analysis, or machine learning-based emotion recognition.

The term “distribute the information to an appropriate department” refers to routing, forwarding, or assigning the user's information, or data derived therefrom, to a designated organizational unit, team, system module, or responsible party that is suitable for handling the user's issue or condition.

The term “appropriate department” refers to a predetermined or dynamically selected organizational unit, team, or specialized support function that is deemed suitable to process user information based on factors such as topic, urgency, or emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

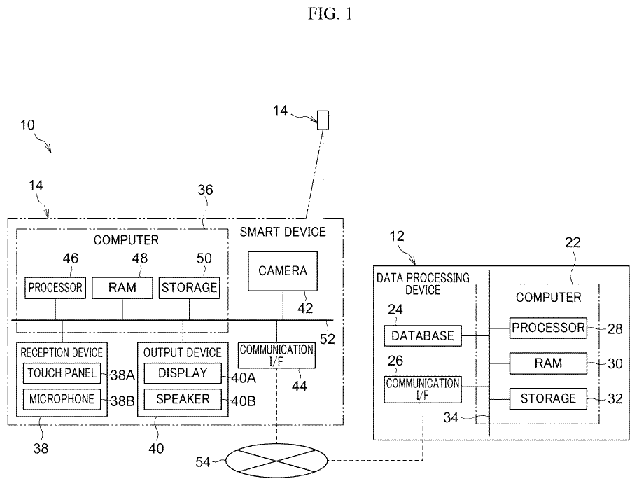

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

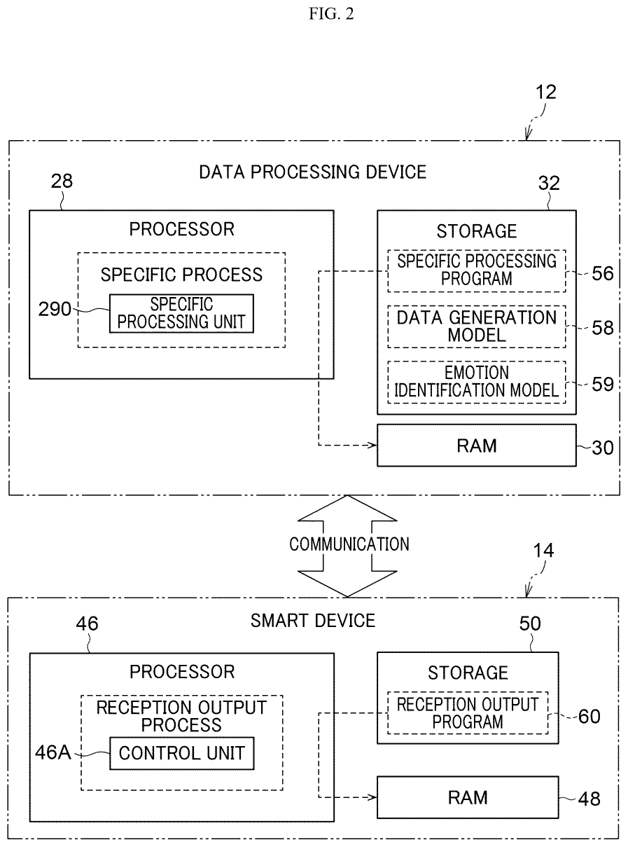

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that use a generative AI model to provide counseling-like feedback rely on ad hoc prompt construction and shallow context handling. As a result, such systems often fail to maintain coherent personalization across sessions, cannot reliably adapt the level of detail or difficulty of proposed actions to a user's abilities, and may generate outputs that are not safely formatted for direct presentation to the user. In particular, conventional architectures typically treat the prompt sentence as a simple concatenation of the latest user input and a small amount of history, without systematic integration of user attribute information, skill information, personality information, and current situation information stored in a storage device. This leads to several technical problems in the operation of computer resources.

First, without structured context integration and length control, the system may exceed the allowable token length of the generative AI model, forcing naive truncation at the transport layer or model interface. Such truncation can remove critical parts of the dialogue history and introduce incoherent responses, thereby degrading the effectiveness of the model and wasting computational resources due to repeated retries and model invocations. From the standpoint of computer technology, the absence of a context-aware token-length management mechanism results in inefficient use of bandwidth, processor cycles, and model capacity.

Second, conventional systems lack a programmatic pipeline that transforms raw generated text into structured response data with explicit separation between an empathetic response portion and an action plan portion. In the absence of such structuring, downstream modules must parse free-form natural language, which increases processing complexity, reduces determinism in UI rendering, and complicates logging and reuse of dialogue history as machine-processable data. This lack of structure impedes efficient indexing, retrieval, and reuse of prior interaction data in storage devices, and hampers scalable personalization.

Third, many existing implementations do not incorporate a dedicated content safety determination and format shaping stage between generation and output. This can lead to situations where unsafe, incomplete, or ill-formatted responses are transmitted to a terminal, necessitating additional client-side checks, user corrections, or repeated requests. These behaviors increase network traffic, processing overhead at both server and terminal, and latency in the human-computer interaction, which represents a technical degradation of the overall system performance.

Fourth, conventional dialog systems do not tightly couple user interface customization parameters such as appearance, color, font size, voice profile, and speaking rate with the server-side response generation pipeline. User interface personalization is often implemented only at the terminal side and is not reflected in server-side control of output format and structure. Consequently, the server cannot optimize the response structure and content for the configured interface characteristics, and cannot consistently store such characteristics as part of the dialogue context. This prevents the system from using interface preferences as contextual signals in prompt generation, limiting the ability of the server to use stored settings to improve subsequent interactions.

Fifth, in many architectures, storage of dialogue history is limited to raw text logs that are not normalized or associated with the actual prompt sentences and generated structured responses. This makes it difficult to efficiently reconstruct or analyze past interactions for future prompt generation, monitoring, or tuning. From a computer-technical perspective, the lack of an integrated representation of context (including prompt, response, and metadata) leads to redundant storage, inefficient queries, and increased processing time when assembling context for the generative AI model.

Therefore, there is a need for a computer-implemented system that, at the server level, systematically constructs a structured prompt sentence from integrated user profile and dialogue history, performs token-length-aware context selection, generates and post-processes output from a generative AI model into structured response data with explicit safety and formatting guarantees, stores such data in a form suitable for subsequent reuse, and reflects user interface preferences as part of the response generation and output pipeline. Such a system should improve the efficiency, reliability, and scalability of generative AI-based dialog processing from the standpoint of computer technology, by reducing unnecessary computation and network traffic, by enabling more deterministic downstream processing, and by enhancing the manageability of large-scale contextual information in storage devices.

The specific processing by the specific processing unit 290 of the data processing device 12 in Example 1 is realized by the following means.

The present invention provides a server comprising a processor and a storage device, the processor being configured to provide, via a display device and an input device of an information processing device, an interactive screen for receiving voice information or character information from a user; convert the voice information into character information by using a speech recognition program; generate dialogue data including the character information and user identification information; transmit the dialogue data via a communication path; retrieve, on the basis of the user identification information, user attribute information, skill information, personality information, current situation information, and past dialogue history information stored in the storage device; integrate the dialogue data and the retrieved information to generate context information; generate, on the basis of the context information, a prompt sentence including at least a role instruction for a system, the user attribute information, the past dialogue history information, and current user input information by executing character string manipulation processing; convert the prompt sentence into input data for input to a generative AI model; input the input data to the generative AI model and cause the generative AI model to generate, by executing numerical operations including matrix operations and an attention mechanism, generated text including response information and individualized action plan information for the user; perform content safety determination processing and format shaping processing on the generated text, identify an empathetic response portion and an action plan portion, and reconstruct the generated text as structured response data; write the structured response data into the storage device in association with the dialogue data and store the structured response data as new dialogue history for reference in subsequent prompt sentence generation; perform display control and audio output control to output the structured response data as character information on the display device or to convert the structured response data into voice information by using a speech synthesis program and output the voice information from an acoustic output device; and receive, in response to a user operation, setting information specifying dialogue interface characteristics including at least one of an appearance display of artificial intelligence, color, character size, voice synthesis speaker profile, and speaking rate, and reflect the setting information in subsequent response generation and output format. This enables the server to improve the efficiency and reliability of generative AI-based dialog processing by performing context-aware prompt construction with token-length control, by generating and storing structured response data suitable for deterministic rendering and reuse, by enforcing server-side safety and formatting guarantees prior to output, and by using stored user interface preferences and profile information as contextual signals in the generation pipeline, thereby enhancing utilization of processing resources, storage resources, and network resources in the overall computer system.

The term “processor” refers to a hardware or virtual computation unit, such as a central processing unit or a processing core, that executes computer-readable instructions to perform the functions described in the system.

The term “storage device” refers to a hardware component, such as a semiconductor memory, magnetic storage, or optical storage, that stores data, programs, and metadata used by the processor.

The term “information processing device” refers to an electronic apparatus, such as a smartphone, tablet, or personal computer, that includes at least a processor, a storage device, a display device, and an input device, and that participates in interaction with a user.

The term “display device” refers to a component, such as a liquid crystal display, an organic light-emitting diode panel, or another visual output apparatus, that presents visual information to a user.

The term “input device” refers to a component, such as a touch panel, keyboard, pointing device, or microphone, that receives operation information, voice information, or character information from a user.

The term “interactive screen” refers to a user interface screen displayed on the display device, which includes one or more input fields, buttons, or controls that allow the user to enter voice information or character information and to operate dialog functions.

The term “voice information” refers to audio data representing spoken utterances of the user, including analog or digital representations of sound signals.

The term “character information” refers to text data composed of characters or symbols that represent user input, including letters, numerals, and punctuation.

The term “speech recognition program” refers to software that analyzes voice information and converts the voice information into character information using pattern recognition, acoustic modeling, or language modeling.

The term “dialogue data” refers to structured data that includes at least the character information obtained from user input and identification information associated with the user, and that represents one or more turns of a dialog.

The term “user identification information” refers to data that uniquely or pseudo-uniquely identifies a user within the system, such as an account identifier, device identifier, or session identifier.

The term “communication path” refers to a logical or physical data transmission route, such as a wired or wireless network, through which dialogue data and other information are transmitted between the information processing device and the server.

The term “transmission unit” refers to a function or module executed by the processor that formats, packages, and sends data, including dialogue data, from one device to another via the communication path.

The term “user attribute information” refers to data representing characteristics of the user, such as age, occupation, or other profile attributes, that are stored in the storage device.

The term “skill information” refers to data indicating abilities or proficiency levels of the user in specific domains, such as technical skills, communication skills, or other capabilities.

The term “personality information” refers to data describing behavioral tendencies, personality traits, or habitual response patterns of the user.

The term “current situation information” refers to data representing a present state or context of the user, including environmental conditions, ongoing projects, or stress-related factors.

The term “past dialogue history information” refers to stored records of previous interactions between the user and the system, including user messages, system responses, prompts, and associated metadata.

The term “context information” refers to combined data that integrates the dialogue data, user attribute information, skill information, personality information, current situation information, and past dialogue history information, and that is used to generate a prompt sentence.

The term “role instruction for a system” refers to a part of the prompt sentence that specifies a behavior, function, or style that the generative AI model is to adopt when generating a response.

The term “current user input information” refers to character information corresponding to a most recent message or query entered by the user in the interactive screen.

The term “prompt sentence” refers to a text or token sequence constructed by the processor that includes at least instructions, context information, and current user input information, and that is supplied as input to the generative AI model.

The term “character string manipulation processing” refers to operations performed on text data, such as concatenation, insertion, formatting, or truncation, to construct or modify the prompt sentence.

The term “input data” refers to a representation of the prompt sentence that is formatted, encoded, or tokenized according to specifications of the generative AI model so as to be acceptable as input to the model.

The term “generative AI model” refers to a machine learning model, such as a neural network-based language model, that receives input data and generates text or other outputs by performing numerical computations.

The term “numerical operations” refers to arithmetic or algebraic computations, including matrix operations and attention mechanisms, executed by the generative AI model to transform input data into output data.

The term “matrix operations” refers to linear algebra operations, such as matrix multiplication, addition, or transformation, that are applied to vector or matrix representations of tokens or features.

The term “attention mechanism” refers to a computation process within the generative AI model that weights different parts of the input data or intermediate representations to focus on relevant information when generating output.

The term “generated text” refers to text output produced by the generative AI model, including response information and individualized action plan information intended for the user.

The term “response information” refers to content within the generated text that directly replies to or engages with the user's input, including explanations, suggestions, or clarifications.

The term “individualized action plan information” refers to content within the generated text that proposes one or more concrete actions tailored to the user's attributes, skills, personality, and current situation.

The term “content safety determination processing” refers to analysis performed on the generated text to detect the presence of unsafe, inappropriate, or undesirable content according to predefined rules or models.

The term “format shaping processing” refers to processing that modifies the structure, layout, or segmentation of the generated text to conform to a desired format, such as separating sections or converting lists.

The term “empathetic response portion” refers to a part of the generated text that expresses understanding, validation, or emotional support toward the user.

The term “action plan portion” refers to a part of the generated text that describes one or more suggested actions, steps, or plans for the user to follow.

The term “structured response data” refers to a representation of the generated text that is organized into discrete fields or segments, including at least an empathetic response portion and an action plan portion, for machine processing and presentation.

The term “display control” refers to processing that determines how structured response data is rendered on the display device, including placement, formatting, and timing of visual output.

The term “audio output control” refers to processing that determines how structured response data is converted to and presented as audio, including invocation of a speech synthesis program and control of playback on an acoustic output device.

The term “speech synthesis program” refers to software that converts character information into voice information by generating audio signals corresponding to spoken language.

The term “acoustic output device” refers to a component, such as a speaker or earphone, that outputs sound based on audio signals produced by the system.

The term “dialogue interface characteristics” refers to parameters that define visual or auditory aspects of the dialog interface, including at least one of appearance display of artificial intelligence, color, character size, voice synthesis speaker profile, and speaking rate.

The term “appearance display of artificial intelligence” refers to a visual representation or avatar shown on the display device to express the presence or identity of the artificial intelligence in the user interface.

The term “character size” refers to a visual parameter that specifies the height or scale of text characters displayed on the display device.

The term “voice synthesis speaker profile” refers to a set of parameters or an identifier used by the speech synthesis program to determine a voice type, such as pitch, tone, or timbre, used for synthesized speech.

The term “speaking rate” refers to a parameter that specifies the speed at which synthesized speech is output, for example as words per minute or a relative rate factor.

The term “setting information” refers to data indicating user-specified preferences related to dialogue interface characteristics, which are received from the user and used to control subsequent response generation and output format.

In one embodiment, the system includes a server, one or more terminals, and a network connecting the server and the terminals. The server includes at least one processor, a main memory, a non-volatile storage device, and a network interface. The terminal includes a processor, a memory, a display device, an input device, a microphone, an acoustic output device, and a communication module. The server and the terminal execute programs stored in their respective storage devices to implement the dialog functions described below.

The terminal operates as an information processing device that presents a user interface and captures user input. The terminal executes an operating system, such as a general-purpose mobile operating system or desktop operating system, and executes an application responsible for dialog interaction. The application displays a chat-style interactive screen on the display device. The terminal receives character information from the user via a touch screen keyboard, hardware keyboard, or pointing device, and receives voice information via the built-in microphone. The terminal, in response to a voice input mode, uses a speech recognition program (for example, a generic cloud speech recognition service or an on-device speech recognition library) to transform audio waveforms into character information. The terminal stores captured audio as digital samples in memory, passes the samples to the speech recognition program, and receives recognized text as a sequence of characters, which the terminal then displays in an input field for confirmation and editing by the user.

The terminal generates dialogue data by constructing a data structure that includes at least the recognized or typed character information, user identification information (such as a user account identifier or device identifier), timestamp information, and an indication of input type (voice or text). The terminal uses a serialization library to convert this dialogue data into a structured representation, such as a sequence of key-value pairs formatted as a data object, and transmits the dialogue data to the server via the network interface using a secure protocol, such as HTTPS. The terminal may temporarily store outgoing and incoming dialogue data in a local cache to maintain a coherent display of the dialog history in the user interface.

The server receives dialogue data from the terminal through the network interface and passes the received data to an application program executed by the server processor. The server stores user attribute information, skill information, personality information, current situation information, and past dialogue history information in the storage device, for example in a relational database or a key-value store. The server retrieves user-related records by using the user identification information included in the dialogue data as a query key. The server reads fields such as age, occupation, capability levels, personality traits, and recorded descriptions of current stressors from the storage device, and also retrieves multiple previous dialogue records associated with the same user, including prior user messages, system responses, and prompts previously sent to the generative AI model.

The server generates context information by integrating the new dialogue data with the retrieved user-related records. The server forms a composite data structure containing, at minimum, the latest user message, selected previous user messages and responses, and structured user profile information. The server uses a set of rules to select a predetermined number of utterance units from the past dialogue history information. For example, the server selects the most recent twenty pairs of user and system messages, or selects those messages that are tagged as emotionally salient or decision-relevant. The server aggregates these elements into a canonical internal representation that can be transformed into a prompt sentence.

The server constructs a prompt sentence for a generative AI model by executing character string manipulation processing on the context information. The server arranges the prompt sentence into sections, such as a system role instruction section, a user profile section, a dialogue history section, a current user message section, and a task section. The server inserts values of user attribute information, skill information, personality information, and current situation information into a template for the user profile section, and formats past dialogue history information into a sequence of lines prefixed with labels such as “User:” and “Assistant:”. The server then inserts the latest character information from the dialogue data into the current user message section. The server generates a role instruction that directs the generative AI model to behave as an empathetic counselor and to produce both a response portion and an action plan portion, and places this instruction in the system role instruction section.

For example, the server may construct a prompt sentence as follows:
“System: You are an empathetic AI counselor. You provide psychologically safe, concrete feedback and simple action plans.

User profile:
Age: 30
Occupation: Marketing specialist
Skills: Presentation (intermediate), data analysis (basic)
Personality: Introverted, tends to avoid confrontation
Current situation: Under pressure due to an upcoming product launch

Dialogue history:
1) User: I often feel nervous before meetings.
2) Assistant: What parts of the meetings make you most nervous?

Current user message:
User: Recently, my work is not going well.
Task: Based on the user profile, dialogue history, and current message, generate an empathetic response. Ask one or two clarifying questions and propose a simple, concrete action the user can take today.”

The server converts the prompt sentence into input data suited for a generative AI model. In one embodiment, the server uses a tokenizer provided with a neural network-based language model to convert the prompt sentence into a sequence of integer token identifiers. The server computes the total number of tokens and compares this number to a maximum context length supported by the generative AI model. The server performs length control by discarding or summarizing less important parts of the past dialogue history information when the total token count exceeds the threshold. The server uses summarization rules or a separate summarization model to compress prior content into a shorter representation, thereby preserving essential semantic information while reducing token count. This non-naive, model-aware truncation strategy reduces the number of failed or repeated model calls and improves computational efficiency, because the server avoids sending oversized inputs that the model cannot process.

The server applies content-aware selection and summarization rules that differ from human manual editing. For example, the server assigns weights to utterances based on recency, presence of specific emotional keywords, or references to ongoing tasks, and uses these weights to select utterances for inclusion. The server may compute these weights using a lightweight classifier or rule-based keyword matching. By doing so, the server uses a machine-specific scoring mechanism to optimize the use of limited context length, which leads to improved response coherence and reduces redundant computations in the generative AI model.

The server executes a generative AI model that is implemented as a neural network, such as a transformer-based language model. The generative AI model includes multiple layers of self-attention blocks and feedforward networks, each layer performing matrix operations and non-linear transformations on embedded token vectors. The server stores trained model parameters in the storage device and loads them into main memory for inference. The model parameters include weight matrices and bias vectors for attention heads, projection layers, and feedforward layers. The server uses hardware such as general-purpose processors or graphics processing units to perform matrix multiplications, vector additions, and softmax operations, which constitute numerical operations necessary for the model to transform input token sequences into output token sequences.

The server, in the training phase of the generative AI model, uses a dataset of dialog pairs and corresponding action plans and trains the neural network with a supervised learning method. The server computes a loss function such as cross-entropy between predicted token probabilities and actual target tokens, and updates model weights by backpropagation and stochastic gradient descent or a variant thereof. The server may apply data augmentation techniques, such as paraphrasing of user messages or random masking of tokens, to improve generalization. The server may pretrain the model on large general text corpora and then fine-tune the model on counseling-style dialog data, thereby adapting the generative behavior to the target domain.

The server, during inference, supplies the tokenized prompt as input to the generative AI model and controls generation parameters such as maximum number of output tokens, temperature for sampling, and top-p or top-k values for controlling diversity. The server receives generated token sequences from the model, decodes them into character information, and designates the resulting text as generated text. The generated text contains both a response information portion and an individualized action plan information portion. The generative AI model, by virtue of its multi-layer attention architecture, can reference user profile tokens and dialogue history tokens when computing attention scores, thereby producing outputs that are conditioned on long-range contextual features in a manner not achievable by simple rule-based systems or human operators that do not have direct access to the same machine-optimized representations. As a result, the server achieves technical improvements in the coherence and relevance of generated responses while maintaining computational efficiency.

The server performs content safety determination processing and format shaping processing on the generated text. The server uses a secondary classifier or rule-based engine to scan the generated text for prohibited phrases, risky suggestions, or formatting anomalies. The server may implement the classifier as a smaller neural network that takes tokenized generated text as input and outputs probability scores for categories such as “safe,” “needs revision,” or “reject.” The server applies threshold rules to these scores to decide whether to accept, modify, or regenerate the response. This processing reduces the need for client-side corrections and mitigates the risk of presenting unsuitable content to the user, thereby improving the reliability of the end-to-end computer system.

The server shapes the format of the generated text by parsing markers, headings, or patterns in the text and segmenting the text into an empathetic response portion and an action plan portion. The server may insert structural tags such as “Empathy:” and “Action plan:” into the prompt sentence to encourage the generative AI model to output clearly separated sections, thereby simplifying downstream parsing. The server re-encodes the parsed content into structured response data, which is an internal representation comprising fields such as “main_message,” “clarifying_questions,” and “action_items.” The server, by maintaining this structured form, enables fast indexing and retrieval of past action plans and response fragments, and reduces computational overhead when rendering output on diverse user interfaces.

The server writes the structured response data into the storage device as part of the past dialogue history information, linking it to the original dialogue data and prompt sentence used for generation. The server stores timestamps, user identification information, and model identifiers along with the structured response data. The server uses efficient database schemas and indexing strategies to support queries that retrieve recent histories, specific types of actions, or summaries of user trajectories. This organized data management improves retrieval speed and allows the server to assemble context information for future prompt sentences without scanning raw text logs, thus improving system throughput and reducing input-output operations on the storage device.

The server performs display control and audio output control based on the structured response data and user interface preferences stored as setting information. The terminal receives structured response data from the server and displays the empathetic response portion and action plan portion in separate visual segments, such as distinct chat bubbles or collapsible sections. The terminal may render bullet-point lists for action items and highlight them with specific colors or icons. The server, by specifying the structure in a machine-readable format, allows the terminal to render consistent layouts without performing complex natural language parsing, thereby reducing terminal-side computation and improving response time.

The terminal, when voice output is enabled, receives text corresponding to the empathetic response portion and the action plan portion and passes the text to a speech synthesis program. The speech synthesis program converts the character information into digital audio waveforms by using a text-to-speech algorithm, which may include phoneme conversion, prosody prediction, and waveform generation using a vocoder. The terminal outputs the synthesized audio via the acoustic output device. The server and the terminal coordinate to adjust parameters such as speaking rate and voice profile according to the setting information supplied by the user, thereby controlling machine hardware in a concrete manner.

The user operates the terminal to customize dialogue interface characteristics, such as the appearance display of artificial intelligence, color, character size, voice synthesis speaker profile, and speaking rate. The terminal transmits updated setting information to the server. The server stores the setting information in association with the user identification information and uses these settings as contextual signals when constructing subsequent prompt sentences and structured response data. For example, the server may generate shorter action plans with fewer steps when the terminal is configured to display large characters, reducing scrolling and improving readability. The server thus uses user interface preferences not merely as presentation parameters but also as input to the response generation logic, which leads to more efficient use of display and communication resources.

In an alternative embodiment, the server executes multiple generative AI models with different sizes or capabilities and selects a model based on the amount of available context or the type of user request. The server may use a smaller, faster model for routine clarifications and a larger model for complex, multi-turn planning. The server, by dynamically choosing models according to internal state and resource availability, improves overall computational throughput and reduces latency. The server can further compress dialogue history by using a dedicated summarization model to generate concise representations of long interactions, thereby enabling the main generative AI model to operate within its context window while still leveraging long-term information.

In another embodiment, the server employs rule-based post-processing to adjust technical depth and difficulty level of the action plan portion according to the skill information of the user. The server uses a mapping from skill levels to vocabulary sets and explanation patterns, and applies these mappings to rewrite or annotate certain terms in the generated text. This non-conventional combination of neural generation and rule-based adaptation yields technical advantages, because it exploits machine-interpretable skill metadata that would not be consistently used in a manual counseling session, and it reduces ambiguity for the user while requiring fewer re-queries to clarify misunderstood instructions.

The server, through the combination of structured context integration, token-length-aware prompt construction, neural generation with explicit architectural features, safety filtering, and structured storage of responses, provides improvements to computer technology. The server reduces unnecessary invocations of the generative AI model and avoids transport-level errors caused by oversized prompts, thereby reducing computation time and network traffic. The server simplifies terminal processing by delivering structured response data, which enables faster rendering and reduced parsing costs. The server improves the accuracy and coherence of generated responses by systematically reusing structured user profile information and past dialogue history, leading to fewer repeated queries and reduced resource consumption. The server, by integrating user interface settings into server-side processing, also optimizes the use of limited screen space and audio bandwidth. These technical effects are realized through specific data structures, algorithmic rules, and neural model operations, and are not achieved by mere automation of human counseling tasks.

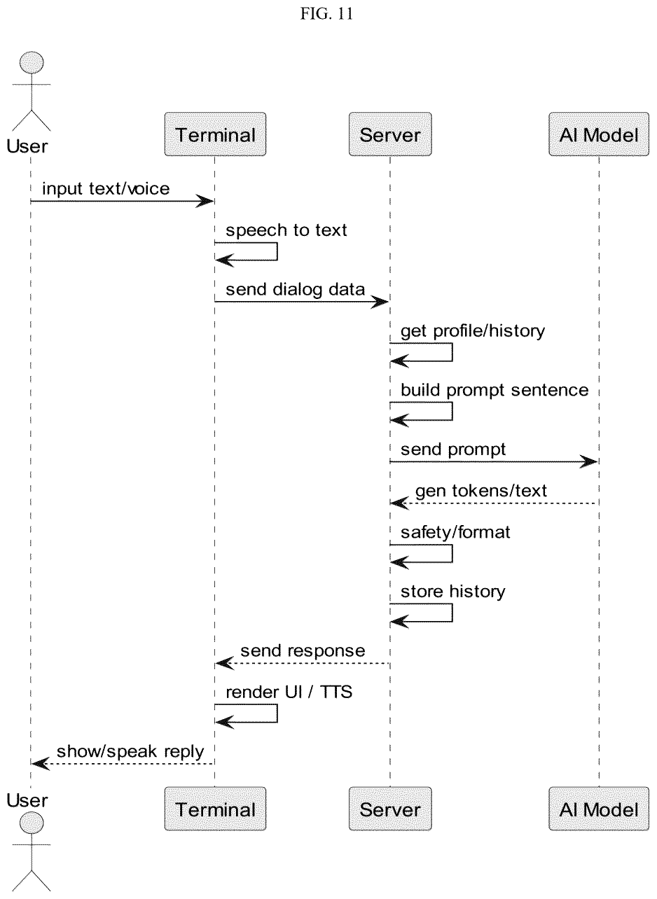

The following describes the processing flow using FIG. 11.

### Step 1:

The user operates the terminal to start a dialog session and input a message. The terminal displays an interactive screen with a text input field and a microphone button. The user inputs text using a keyboard, or speaks into the microphone to provide voice information. The terminal captures key events or audio samples as raw input data. The input of this step is user operation signals (keystrokes or audio signals), and the output is raw text or audio data held in the terminal memory.

### Step 2:

The terminal converts voice information into character information when the user selects voice input. The terminal passes buffered audio samples to a speech recognition program and receives a recognized text sequence. The terminal may display this recognized text in the input field for user confirmation and editing. The input of this step is recorded audio data, and the output is character information representing the user's spoken message.

### Step 3:

The terminal constructs dialogue data and prepares it for transmission. The terminal creates a data structure containing the character information, user identification information, device identification information, timestamp, and input type. The terminal serializes this structure into a transmission format and performs basic validation, such as checking that the message is not empty. The input of this step is the user's final character information and associated identifiers, and the output is a structured dialogue data object ready to be sent to the server.

### Step 4:

The terminal transmits the dialogue data to the server over a network. The terminal opens a secure communication channel and sends the serialized dialogue data as a request message. The terminal starts a response timer and waits for a reply from the server. The input of this step is the structured dialogue data object, and the output is a network request carrying the dialogue data to the server.

### Step 5:

The server receives the dialogue data and performs initial parsing. The server accepts the network request via a network interface, forwards the request to an application layer, and deserializes the dialogue data into internal variables. The server validates user identification information and checks basic integrity of the message. The input of this step is the received network request containing serialized dialogue data, and the output is an internal representation of the dialogue data, including the user's current message and metadata.

### Step 6:

The server retrieves user profile and past dialogue history from a storage device. The server uses the user identification information as a key to query stored user attribute information, skill information, personality information, and current situation information. The server also retrieves multiple records of past dialogue history associated with the same user. The input of this step is the internal dialogue data including user identification information, and the output is a set of retrieved records containing user profile and past dialogue history information.

### Step 7:

The server generates context information by integrating the new dialogue data with the retrieved records. The server selects a predetermined number of utterance units from the past dialogue history according to recency and importance, and merges them with the current message and user profile. The server may compute importance scores using rules or a classifier and discard low-score utterances. The input of this step is the user's current dialogue data and the retrieved profile and history records, and the output is a unified context information structure suitable for prompt construction.

### Step 8:

The server performs token-length-aware selection and summarization on the dialogue history portion of the context. The server estimates the number of tokens required to encode the context information and compares this estimate with the maximum context length of the generative AI model. The server truncates or summarizes older or less important utterances using summarization rules or a separate summarization model to maintain essential information within the length limit. The input of this step is the initial context information, and the output is length-controlled context information that satisfies the token constraints of the generative AI model.

### Step 9:

The server constructs a prompt sentence from the length-controlled context information. The server generates a system role instruction, formats user attribute information and skill information into a profile section, converts selected dialogue history into labeled text lines, and inserts the current user message into a dedicated section. The server adds a task description instructing the generative AI model to produce an empathetic response and an individualized action plan. The input of this step is the length-controlled context information, and the output is a complete prompt sentence in text form.

### Step 10:

The server tokenizes the prompt sentence and prepares input data for the generative AI model. The server applies a tokenizer associated with the generative AI model to convert the prompt sentence into a sequence of token identifiers. The server organizes these identifiers into tensors or arrays required by the model interface. The input of this step is the textual prompt sentence, and the output is tokenized input data suitable for direct ingestion by the generative AI model.

### Step 11:

The server invokes the generative AI model to generate output tokens. The server sends the tokenized input data and generation parameters (such as maximum output length, temperature, and sampling strategy) to the model inference engine. The model engine performs matrix multiplications, attention computations, and non-linear activations across multiple layers to compute probability distributions over next tokens. The server receives the sequence of generated token identifiers from the model. The input of this step is the tokenized prompt and generation parameters, and the output is a sequence of generated token identifiers representing the model's raw response.

### Step 12:

The server decodes the generated token identifiers into generated text. The server uses the same tokenizer to map tokens back to characters and concatenates them into a continuous text string. The server may normalize whitespace and punctuation during this decoding process. The input of this step is the sequence of generated token identifiers, and the output is generated text that contains both response information and candidate action plan information.

### Step 13:

The server performs content safety determination processing on the generated text. The server passes the generated text through a safety module that may use keyword rules, pattern matching, or a classification model to determine whether the text includes unsafe or undesirable content. The server compares computed risk scores with predefined thresholds, and, if necessary, masks, edits, or requests regeneration of problematic portions. The input of this step is the raw generated text, and the output is a safety-filtered text version that satisfies content policies.

### Step 14:

The server performs format shaping processing and extracts structural components from the safety-filtered text. The server detects markers or patterns that separate an empathetic response portion from an action plan portion and splits the text accordingly. The server restructures the text into a machine-readable structured response data object with fields for empathy statements, clarifying questions, and action items. The input of this step is the safety-filtered generated text, and the output is structured response data that explicitly encodes distinct sections of the response.

### Step 15:

The server personalizes and adjusts the structured response data according to user profile and skill information. The server examines the user's skill levels and personality traits and, using rule-based mapping, simplifies technical terms, adds explanations, or adjusts the number and difficulty of action items. The server may reorder or annotate action items to match the user's current situation. The input of this step is the structured response data and the user profile information, and the output is an updated structured response data object tailored to the user's capabilities and context.

### Step 16:

The server stores the new structured response data as part of the past dialogue history. The server constructs a dialogue history record that includes the original dialogue data, the prompt sentence, the generated text, and the final structured response data, and writes this record into the storage device. The server creates or updates indexes to support efficient retrieval of recent history and action plans. The input of this step is the tailored structured response data together with the original dialogue data and prompt, and the output is an updated dialogue history database that incorporates the new interaction.

### Step 17:

The server prepares a response message to send to the terminal. The server wraps the structured response data, including labeled empathy and action components, into a response structure suitable for transmission. The server includes any presentation hints or interface flags derived from user settings, such as indicators to enable voice playback. The input of this step is the tailored structured response data and user interface settings, and the output is a transmission-ready response message destined for the terminal.

### Step 18:

The terminal receives the response message from the server and updates the user interface. The terminal deserializes the response structure, extracts the empathetic response portion and the action plan portion, and renders them as separate visual elements on the interactive screen. The terminal may display action items as bullet points or buttons to facilitate user understanding and interaction. The input of this step is the response message received from the server, and the output is an updated screen display showing the system's feedback and suggested actions.

### Step 19:

The terminal optionally generates audio output from the received response. The terminal checks user settings for voice output, and, if enabled, passes the textual empathy and action plan portions to a speech synthesis program. The terminal converts the resulting audio data into sound using the acoustic output device. The input of this step is the textual portions of the structured response data and voice settings, and the output is audible speech that presents the feedback and action plan to the user.

### Step 20:

The user reviews the displayed or spoken feedback and determines the next action. The user may follow one or more suggested action items or provide additional details or questions through the terminal interface. The user's subsequent input, whether confirming actions taken or introducing new concerns, becomes the next round of dialogue data. The input of this step is the structured response presented to the user, and the output is new user input that reenters the processing flow beginning with subsequent steps at the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented advisory systems, including systems that use statistical models or rule-based engines, typically generate generic guidance that is not sufficiently tailored to an individual user's security context, technical skill, or behavioral tendencies. In particular, known systems often (i) treat each user query in isolation without deeply integrating structured analyses of past behavior history, (ii) rely on ad hoc or static templates rather than dynamically constructed prompt sentences when invoking a generative AI model, and (iii) do not systematically adjust the content, sequence, and tone of responses based on a quantified emotional state of the user. As a result, these systems tend to provide either overly generic or overly complex instructions, which can reduce user comprehension and adherence, and ultimately fail to reduce actual security risk in a measurable way. From a computer-technology perspective, there is a need for improved methods of orchestrating heterogeneous software components such as natural language processing engines, generative AI models, data storage components, and user interface modules in a coordinated manner that produces more context-aware and behaviorally effective output. Existing architectures commonly pass raw or lightly processed user text directly to a language model, leaving the model to infer user characteristics and context from noisy input. This leads to inefficiencies in model utilization, inconsistent output quality, and limited controllability over the generated responses, which can be problematic for safety-critical domains like personal security.

Furthermore, conventional systems do not adequately leverage the accumulated behavior history on a per-user basis as a first-class input into the generation pipeline. Such systems may store logs of user interactions, but they rarely transform these logs into explicit feature values that are systematically incorporated into the creation of prompts for the generative AI model. Consequently, the computing infrastructure is underused: storage and processing resources maintain user data but do not translate it into structured, machine-readable guidance that can reliably shape the model's responses.

In addition, known systems generally lack a robust mechanism for controlling response style and complexity through explicit, machine-generated instructions embedded in the prompt sentence supplied to the generative AI model. Without such control, the system may produce advice that is not aligned with the user's security literacy level, emotional state, or current risk profile. This can increase cognitive load, reduce the effectiveness of the advice, and diminish the overall performance and reliability of the computer system as a security advisory platform.

Therefore, there is a need for a computer-implemented technique that (i) converts raw user input into structured data representing security-related interests, risk factors, and emotional state, (ii) computes feature values from stored attribute and behavior history information to form a persistent user profile, (iii) constructs a prompt sentence for a generative AI model that explicitly encodes this user profile together with response policy instructions, and (iv) uses the resulting generative AI output in a controlled, post-processed manner, while continuously updating and reusing the user's behavior history. By improving how the processor structures, aggregates, and reuses user-specific information to control generative AI behavior, such a technique would provide a concrete improvement in the operation of computer systems that generate personalized security guidance.

The specific processing by the specific processing unit 290 of the data processing device 12 in Application Example 1 is realized by the following means.

The present invention provides a server comprising a processor configured to provide, on a terminal, a user interface for acquiring information from a user via character input or voice input, and to receive the information from the terminal via a communication line, to analyze the received information by using general-purpose software for natural language processing to perform morphological analysis, syntactic analysis, and semantic analysis, to generate structured data indicating a security-related target of interest, a risk factor, and an emotional state of the user, and, on the basis of attribute information and behavior history information of the user stored in a storage device, to calculate feature values representing characteristics, skill level, and safety behavior pattern of the user, to generate a user profile including a current situation, a past behavior history, and the emotional state of the user on the basis of the structured data and the feature values, and to create a prompt sentence by combining the user profile, an original input sentence from the user, and an instruction sentence defining a response policy for a generative AI model, to input the prompt sentence to the generative AI model operating on a general-purpose information processing apparatus or to an external service providing a generative AI model, and to cause the generative AI model to generate a response sentence including feedback and a personalized action plan for reducing a security risk of the user, to perform formatting of an expression form, removal of prohibited expressions, and adjustment of an explanation level on the generated response sentence, to generate audio data by using software for speech synthesis when necessary, and to transmit a result to the terminal so that the result is presented visually or auditorily, and to acquire, from the terminal, operation content performed by the user on the basis of the feedback or the action plan, to store the operation content as the behavior history information in the storage device, and to reflect the stored behavior history information in generation of the prompt sentence in a subsequent processing. This enables the computer system to more effectively structure and reuse user-specific data in controlling the behavior of a generative AI model, thereby improving the technical performance and reliability of the system in generating context-aware, personalized security guidance that better reduces user security risk.

The term “user” refers to a human operator who interacts with the system via a terminal by providing input information and receiving feedback or an action plan.

The term “terminal” refers to an electronic device, such as a computing device or communication device, that presents a user interface to the user, acquires character or voice input from the user, and transmits the acquired information to the server via a communication line.

The term “server” refers to an information processing apparatus, including at least one processor and at least one storage device, that executes the processing for analyzing user input, generating a prompt sentence, invoking a generative AI model, and returning a response to the terminal.

The term “processor” refers to one or more hardware processing units, such as a central processing unit or a graphics processing unit, that execute instructions to implement the functions of analyzing user information, generating a user profile, creating a prompt sentence, calling a generative AI model, and post-processing the model output.

The term “storage device” refers to a hardware storage component, such as a memory unit or a non-volatile storage unit, that stores attribute information, behavior history information, user profiles, and program instructions used by the processor.

The term “communication line” refers to a wired or wireless communication medium, including a local network or a wide-area network, that enables data exchange between the terminal and the server.

The term “user interface” refers to a software-controlled interface presented on the terminal that allows the user to input information via character input or voice input and to view or listen to feedback and action plans provided by the system.

The term “character input” refers to input information provided by the user in textual form, including alphanumeric characters and symbols, through an input device such as a keyboard, touch panel, or virtual keyboard.

The term “voice input” refers to input information provided by the user in the form of spoken utterances, which is captured by an audio input device and converted into text data by speech recognition processing.

The term “natural language processing” refers to automated processing performed by software to analyze and interpret human language text, including operations such as morphological analysis, syntactic analysis, and semantic analysis.

The term “general-purpose software for natural language processing” refers to a software component or library, executable on a general-purpose information processing apparatus, that performs natural language processing tasks without being limited to a specific domain.

The term “morphological analysis” refers to processing that segments a text into tokens or word units and identifies attributes of the tokens such as part of speech.

The term “syntactic analysis” refers to processing that determines grammatical relationships among tokens in a text, such as dependency relations or phrase structures.

The term “semantic analysis” refers to processing that interprets the meaning of a text by identifying semantic roles, entities, and relationships or by extracting context-dependent meaning.

The term “structured data” refers to data organized in a defined format, such as key-value pairs or records, that represents extracted attributes including a security-related target of interest, a risk factor, and an emotional state of the user.

The term “security-related target of interest” refers to an object, resource, or environment relevant to the user's security concern, such as an account, device, service, or data type, identified from the user's input.

The term “risk factor” refers to a condition, event, or behavior associated with an increased likelihood of a security incident for the user, as determined from the analysis of the user's input and history.

The term “emotional state” refers to a psychological condition of the user, such as anxiety, confidence, or confusion, inferred from the user's input by natural language processing.

The term “attribute information” refers to information associated with a user that characterizes the user, such as demographic attributes, technical skill level, preferences, or other static or slowly changing properties.

The term “behavior history information” refers to information specifying past actions, events, or interactions of the user, including responses to prior advice, completed security actions, and incident occurrences, stored chronologically or in an aggregated form.

The term “feature values” refers to numerical or categorical values computed from attribute information and behavior history information that represent characteristics, skill level, and safety behavior patterns of the user in a machine-readable format.

The term “user profile” refers to a data structure including at least a current situation, a past behavior history, and an emotional state of the user, and optionally including feature values and attribute information, used to characterize the user for processing by the system.

The term “prompt sentence” refers to a text string or structured textual content supplied as input to a generative AI model, including at least the user profile, an original input sentence from the user, and an instruction sentence defining a response policy.

The term “original input sentence” refers to a text representation of the information directly provided by the user, before transformation into structured data or summarization.

The term “instruction sentence” refers to a portion of the prompt sentence that explicitly defines a response policy for the generative AI model, including constraints or guidelines on style, content, structure, or tone of the output.

The term “generative AI model” refers to a machine-learned model capable of generating natural language text in response to an input prompt, such as a neural network-based language model executed on a general-purpose information processing apparatus or provided as an external service.

The term “response policy” refers to a set of constraints, objectives, or rules that govern how the generative AI model should produce a response, including required topics, level of detail, target audience, and tone.

The term “response sentence” refers to text output generated by the generative AI model in response to the prompt sentence, including at least feedback and a personalized action plan for the user.

The term “feedback” refers to explanatory or evaluative information presented to the user about the user's security condition, risks, or past actions, generated by the generative AI model.

The term “personalized action plan” refers to a set of one or more recommended actions tailored to the specific user profile, intended to reduce or manage security risk.

The term “formatting of an expression form” refers to processing that adjusts the layout, structure, or style of the response sentence, such as converting text into bullet points, numbered lists, or sections.

The term “removal of prohibited expressions” refers to processing that detects and deletes or replaces text segments in the response sentence that do not comply with predefined safety policies or content restrictions.

The term “adjustment of an explanation level” refers to processing that modifies the complexity, depth, or amount of technical detail in the response sentence in accordance with the user's skill level or preferences.

The term “software for speech synthesis” refers to a software component that converts text data into audio data representing spoken language, using text-to-speech processing.

The term “audio data” refers to digital data representing sound signals, including synthesized speech derived from the response sentence.

The term “operation content” refers to information describing actions taken by the user, such as confirming completion of a recommended step or reporting a change in security settings, acquired from the terminal.

The term “subsequent processing” refers to processing performed after one interaction cycle, including generation of a new prompt sentence and response sentence that take into account updated behavior history information from prior cycles.

The term “step-by-step action guideline” refers to an ordered sequence of discrete steps that a user is instructed to perform to achieve a security-related objective.

The term “degree of specialization of an explanation” refers to a level of technical detail or domain-specific complexity specified for the content of the response sentence.

The term “tone” refers to a qualitative style of expression of the response sentence, such as formal, casual, reassuring, or directive, adjusted for the user's emotional state or preference.

The term “security literacy level” refers to an estimated level of understanding or proficiency of the user with respect to security concepts and practices, derived from attribute and behavior history information.

The term “domain of interest” refers to a category or field within security, such as account protection, device protection, or network protection, to which the user's concern is classified.

The term “type of risk” refers to a classification of a security threat or vulnerability, such as unauthorized access, data leakage, or malware infection, inferred from user input and context.

The term “index indicating the emotional state” refers to a quantitative or categorical measure that represents the inferred emotional condition of the user, and that is used to control presentation order and expression strength.

The term “order of presenting information” refers to the sequence in which elements of the response, such as explanations and action items, are displayed or spoken to the user.

The term “degree of expression strength” refers to the intensity or emphasis of expressions used in the response sentence, including the firmness of recommendations or the urgency conveyed.

In one embodiment, a server cooperates with a terminal operated by a user to implement the claimed system. The server comprises at least one processor, at least one memory, a non-volatile storage device, and a network interface. The terminal comprises a computing device, such as a smartphone, a tablet, or a personal computer, including an input device, a display, an audio input device, an audio output device, and a network communication module.

The terminal provides a user interface for acquiring information from the user. The terminal presents input fields for character input and controls for voice input on a display. The terminal receives character input through a physical keyboard, a touch screen keyboard, or another input device. The terminal receives voice input through a microphone, and a speech recognition module on the terminal or on the server converts the captured audio into text. The terminal transmits the resulting text and associated metadata, such as a user identifier and a timestamp, to the server via a communication network using a network protocol such as HTTPS.

The server receives the information from the terminal through the network interface. The server stores the received text data in the memory in association with the user identifier. The server executes natural language processing software implemented as a general-purpose library, such as a statistical or neural network-based parser, on a general-purpose operating system executing on the processor. The server applies morphological analysis to segment the text into tokens and to assign part-of-speech tags to each token. The server applies syntactic analysis to determine dependency relations among the tokens and to generate a parse structure. The server applies semantic analysis to identify named entities, semantic roles, and contextually relevant phrases.

The server transforms the output of the natural language processing into structured data. The server defines a data structure that includes at least fields indicating a security-related target of interest, a risk factor, and an emotional state of the user. The server determines the security-related target of interest by matching tokens and entities to a domain-specific lexicon that includes categories such as account protection, device protection, data protection, and communication protection. The server determines the risk factor by comparing the extracted context with a set of risk patterns, such as password reuse, suspected credential leakage, absence of multifactor authentication, or evidence of phishing. The server infers the emotional state from linguistic features, such as the presence of anxiety-related expressions, intensity modifiers, and negations, using a classifier trained on annotated text data.

The server accesses attribute information and behavior history information of the user stored in the storage device. The server maintains a user profile database in which each record includes attribute information, such as a security literacy level and preferred communication style, and behavior history information, such as prior security incidents, previous recommendations, and reported actions taken by the user. The server converts the attribute information and behavior history information into feature values. The server represents each user as a feature vector including, for example, numeric values for password change frequency, multifactor authentication adoption rate, number of past incidents, completion rate of recommended actions, and categorical encodings of security literacy level and typical response time.

The server generates a user profile for the current interaction by combining the structured data derived from the current input with the feature values derived from the stored information. The user profile includes at least an indication of a current situation (e.g., suspected password compromise), a past behavior history (e.g., previous failures to enable multifactor authentication), and the emotional state inferred from the current input. The server also determines a response policy, including a desired level of technical detail, a preferred tone (e.g., calm and reassuring), and a requirement for step-by-step instructions based on the security literacy level and the emotional state.

The server creates a prompt sentence for a generative AI model by combining the user profile, an original input sentence from the user, and an instruction sentence defining the response policy. In one example, the prompt sentence has the following form:

System: You are a generative AI model acting as a personalized security advisor. You must provide concrete, step-by-step advice and a personalized action plan.

User profile:
Security literacy: beginner
Password change frequency: more than 300 days
Two-factor authentication: disabled on main email
Incident history: clicked a phishing link in the past
Follow-through rate on advice: 40%

Parsed concern:
Concern type: account password risk
Asset: primary email account
Estimated emotion: anxious

User message:
“I think my email password might have been leaked recently.”

Instructions:
1. Explain briefly why this situation is risky in simple terms.
2. Provide a clear step-by-step action plan the user can perform today.
3. Prioritize enabling two-factor authentication and using strong, unique passwords.
4. Use a calm and reassuring tone.
5. Output only the advice for the user, without mentioning these instructions.

The server constructs the prompt sentence in a structured textual format that follows a predefined template, allowing deterministic insertion of user profile values and analysis results. This explicit structuring improves control over the generative AI model's behavior and reduces variability in output quality compared to naively sending raw user text.

The server inputs the prompt sentence to a generative AI model. In one embodiment, the generative AI model is a neural network-based language model having a transformer architecture. The generative AI model includes an embedding layer, multiple self-attention blocks, feedforward layers, and an output projection layer that maps internal representations to token probabilities. The server executes the generative AI model on a general-purpose information processing apparatus that includes a graphical processing unit optimized for matrix computations. The server may alternatively access an external service providing the generative AI model through an application programming interface.

The server encodes the prompt sentence into token identifiers using a subword tokenizer. The generative AI model processes these token identifiers through multiple attention layers, computing attention weights conditioned on the user profile and instruction segments. Because the user profile, risk factors, and emotional state are explicitly encoded as structured segments, the attention mechanism can more reliably associate specific instructions with relevant parts of the input, thereby improving the consistency and relevance of generated advice. The generative AI model generates the response sentence token by token by sampling from the probability distribution produced at each decoding step, constrained by parameters such as temperature, maximum token count, and repetition penalties.

In one training configuration, the generative AI model is trained in advance on a corpus of security-related dialogues and instructional texts. The server or a training system minimizes a loss function, such as cross-entropy between predicted and target tokens, using gradient-based optimization. The training system updates model weights via backpropagation across the transformer layers. The training data includes examples of desired response policies annotated with user literacy levels and emotional states, so that the generative AI model learns to adapt its responses to these signals when present in the prompt sentence. Data augmentation techniques such as paraphrasing, synonym substitution, and random masking are used to increase robustness of the model to variations in user input.

The server receives the response sentence generated by the generative AI model and performs post-processing. The server enforces content policies by comparing the generated text with a list of prohibited expressions and by applying pattern rules to detect unsafe or confusing content. The server reformats the response sentence into an expression form suitable for display, such as numbered steps for an action plan and short paragraphs for explanations. The server adjusts the explanation level by inserting, simplifying, or removing technical terms according to the security literacy level stored in the user profile. The server constructs a final message that includes both narrative feedback and a personalized action plan.

When audio presentation is required, the server uses software for speech synthesis to convert the final text into audio data. The server selects a speech synthesis voice and prosody parameters that match the desired tone (e.g., calm and moderate speed). The speech synthesis software generates audio waveforms representing spoken language corresponding to the text, and the server packages the audio data in a compressed format suitable for streaming to the terminal.

The server transmits the final text and, where applicable, the audio data to the terminal. The terminal displays the feedback and action plan on the display and plays the audio through an audio output device. The terminal can present the action plan as an interactive list, where the user can mark individual steps as completed or request additional explanations.

The user operates the terminal to perform actions recommended in the personalized action plan. For example, the user may change an account password, enable multifactor authentication, or review recent login activity. The terminal acquires operation content indicating which actions the user has completed, either by direct user confirmation or by monitoring certain system-level events. The terminal sends the operation content back to the server over the communication network.

The server stores the received operation content as updated behavior history information in the storage device. The server updates feature values such as password change frequency, multifactor authentication adoption rate, and follow-through rate on advice. The server updates the user profile to reflect the improved security posture. In subsequent interactions, the server uses the updated feature values when constructing the prompt sentence, which allows the generative AI model to produce advice that acknowledges past improvements and proposes more advanced or different measures.

This configuration of specific data structures and processing steps produces technical effects that go beyond simple automation of human advisory work. By converting raw user text into structured data and explicit feature values, the server reduces the ambiguity presented to the generative AI model and thereby increases the accuracy and stability of model outputs. This reduces the need for repeated queries and corrections, which improves processing efficiency and lowers network traffic. The explicit separation of user profile segments, risk factors, and instruction sentences in the prompt sentence enables the transformer-based generative AI model to allocate attention more efficiently, reducing computational waste on irrelevant tokens and shortening the average inference time for a given quality threshold.

The server achieves improved data management by maintaining user behavior history in a feature-vector form adapted for rapid retrieval and aggregation. Because feature values are precomputed and updated incrementally when new operation content is received, the server avoids repeated re-analysis of complete historical logs, which reduces storage access load and computation cost. The incremental updates also enable real-time adaptation of advice without full retraining or reconfiguration of the model.

The use of explicit instruction sentences in the prompt sentence further improves system behavior. Instead of relying on implicit, emergent behavior, the server composes machine-readable directives that specify step-by-step action guidelines, degree of specialization of explanations, and tone. This non-conventional instruction-driven prompting reduces variance in generated outputs and increases reproducibility of advisory behavior across users with similar profiles. As a result, the system provides more predictable and testable responses, which is a technical improvement relative to unstructured prompting.

The generative AI model operates under rules and procedures that are not typical of human reasoning. For example, the model uses high-dimensional token embeddings and attention weights to decide which segments of the user profile and instruction sentence are relevant to each generated token. The server controls these mechanisms by designing the prompt sentence format and by adjusting sampling parameters. This interaction between structured prompt design and neural attention patterns constitutes a distinctive computational technique that leverages the strengths of machine learning models in a way that cannot be replicated by simple human-written templates or manual responses.

Alternative embodiments are possible. In one variation, the server performs some natural language processing steps on the terminal processor to reduce communication load. In such a case, the terminal executes a lightweight natural language processing module that performs initial tokenization and emotional state estimation and sends intermediate structured data to the server. This hybrid arrangement further reduces data volume and accelerates server-side processing.

In another variation, the generative AI model is implemented as a smaller, on-premise model that handles routine, low-risk queries, while an external, larger model is used only for complex or high-risk queries. The server selects the model based on the risk factor and emotional state extracted from the user input. This model selection mechanism optimizes resource usage and reduces overall latency for typical queries while preserving quality for critical situations.

In yet another embodiment, the server incorporates additional machine learning modules to refine the security literacy level estimation using supervised or semi-supervised learning. The server adjusts feature weights used in the prompt sentence generation based on feedback about whether users successfully complete recommended actions. This adaptive mechanism improves the matching between explanation level and user capacity over time, which reduces misunderstanding and error rates.

Through these configurations, the server, the terminal, and the user interact in a manner that implements the claimed system such that the computer technology is improved. The system enhances the accuracy and consistency of generated security advice, reduces unnecessary computation and communication overhead, and provides a robust, technically grounded framework for controlling and utilizing a generative AI model via carefully constructed prompt sentences and structured user profiles.

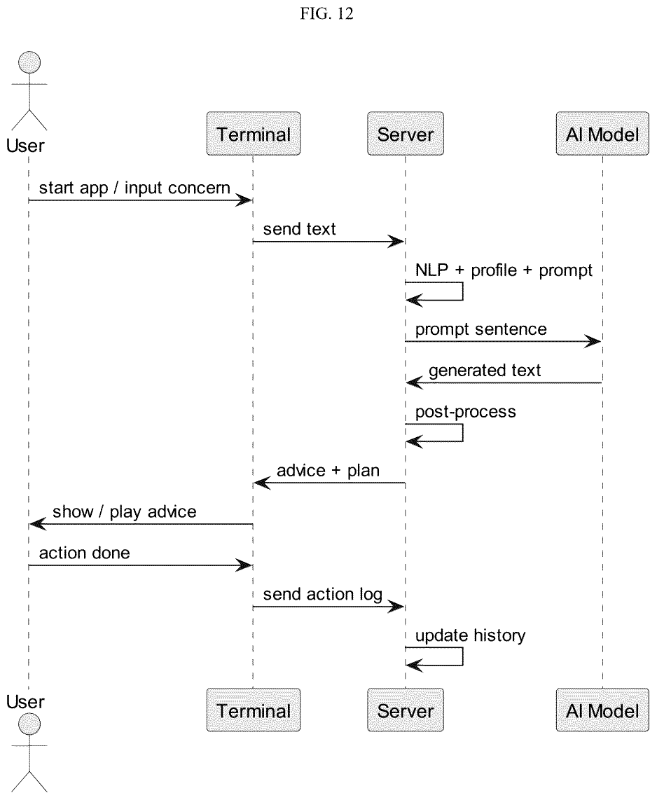

The following describes the processing flow using FIG. 12.

### Step 1:

The user operates the terminal to start an application that provides a security advisory service. The terminal displays an input screen including a text input field and a button for starting voice input. The input of this step is an application launch event generated by the user's operation, and the output is a rendered user interface that can accept character input or voice input from the user.

### Step 2:

The user provides a security-related concern or question to the terminal by typing text or by speaking into a microphone. The terminal receives character input via a keyboard or touch screen and receives audio signals via the microphone. If the user selects voice input, the terminal converts the audio signals into text using a speech recognition module. The input of this step is raw keystroke data or audio waveform data from the user, and the output is a normalized text string representing the user's concern, along with basic metadata such as a timestamp and a device identifier.

### Step 3:

The terminal packages the normalized text string and metadata into a request message. The terminal adds a user identifier, a session identifier, and device type information, and then sends this message to the server via a communication network using a secure protocol. The input of this step is the text string and local metadata generated in the previous step, and the output is a network request containing structured request data transmitted to the server.

### Step 4:

The server receives the network request through a network interface and verifies its integrity and format. The server checks that required fields such as user identifier and input text are present and that the message size is within allowable limits. The server then stores the raw input text and associated metadata in a temporary memory area for subsequent processing. The input of this step is the structured request data sent by the terminal, and the output is validated and stored raw input data ready for natural language processing.

### Step 5:

The server executes natural language processing software to analyze the received text. The server applies tokenization, part-of-speech tagging, syntactic parsing, and semantic annotation to the text. Based on the parsed structure, the server identifies security-related targets, such as accounts or devices, and risk factors, such as suspected password leakage or missing multifactor authentication. The server also computes an estimated emotional state by applying a trained classifier to linguistic features. The input of this step is the raw text from the user, and the output is structured data including a security-related target of interest, one or more risk factors, and an emotional state indicator.

### Step 6:

The server accesses attribute information and behavior history information for the user from a storage device. The server retrieves records such as previous incidents, previously recommended actions, and reported completion of those actions. The server converts these records into feature values, such as password change frequency, adoption rate of multifactor authentication, number of past security incidents, and completion rate for recommended steps. The input of this step is the user identifier and stored user-related records, and the output is a feature vector representing the user's characteristics, skill level, and safety behavior pattern.

### Step 7:

The server generates a user profile by combining the structured data from the current input with the feature vector from the stored information. The server assembles a profile that includes a current situation description, a summary of past behavior history, and the inferred emotional state. The server also determines a response policy, including target security literacy level, desired tone, and need for step-by-step instructions, based on the feature values and emotional state. The input of this step is the structured analysis data and the feature vector, and the output is a composite user profile including both current and historical information.

### Step 8:

The server creates a prompt sentence for a generative AI model by inserting elements of the user profile, the original user message, and the response policy into a predefined textual template. The server organizes the prompt into labeled sections such as “User profile,” “Parsed concern,” “User message,” and “Instructions.” By doing so, the server converts internal data structures into a single coherent text that explicitly encodes guidance for the generative AI model. The input of this step is the user profile and the original text message, and the output is a complete prompt sentence formatted for input to the generative AI model.

### Step 9:

The server transmits the prompt sentence to the generative AI model. If the model is hosted externally, the server sends the prompt over an application programming interface; if the model is local, the server passes the prompt to an inference module. The generative AI model encodes the prompt into token embeddings, processes the tokens through attention and feedforward layers, and generates a sequence of output tokens representing an answer. The input of this step is the prompt sentence, and the output is a raw generated text response including preliminary feedback and a candidate personalized action plan.

### Step 10:

The server receives the generated text response from the generative AI model and applies post-processing operations. The server scans the text for prohibited expressions, removes or replaces them according to predefined rules, and restructures the content into a format suited for presentation, such as numbered action steps and explanatory paragraphs. The server adjusts the technical depth and vocabulary complexity in line with the security literacy level encoded in the user profile. The input of this step is the raw generated response text, and the output is a cleaned and formatted response sentence including feedback and a personalized action plan.

### Step 11:

The server optionally generates audio data from the formatted response sentence. When audio presentation is enabled, the server uses speech synthesis software to convert the text into a corresponding audio waveform. The server configures the speech synthesis parameters, such as speaking rate and voice type, based on the desired tone. The input of this step is the finalized response text, and the output is audio data representing spoken feedback and instructions.

### Step 12:

The server sends the final response to the terminal, including the formatted text and, when applicable, the audio data or a reference to it. The server encapsulates the response in a structured message and transmits it over the communication network. The input of this step is the formatted text and optional audio data generated by the server, and the output is a response message delivered to the terminal for user presentation.

### Step 13:

The terminal receives the response message and interprets its contents. The terminal displays the feedback and the personalized action plan on a display and, if audio data is included, plays the audio through a speaker or headphones. The terminal may structure the action plan as interactive items that the user can tap to indicate completion or request additional detail. The input of this step is the response message from the server, and the output is a rendered visual and auditory presentation that the user can perceive and interact with.

### Step 14:

The user reviews the presented feedback and personalized action plan and performs recommended actions, such as changing a password or enabling multifactor authentication. The user then interacts with the terminal to indicate which actions have been completed or to provide a follow-up message. The terminal records these confirmations and follow-up texts as operation content. The input of this step is the displayed or spoken advice from the terminal, and the output is user-generated operation content reflecting completed actions or additional concerns.

### Step 15:

The terminal packages the operation content, including identifiers of completed steps and any follow-up text, into a structured message and transmits it to the server over the communication network. The input of this step is the operation content captured from the user interactions, and the output is an update message sent to the server that indicates changes in the user's behavior history.

### Step 16:

The server receives the update message and updates the behavior history information stored in the storage device. The server adds new records for completed actions, updates summary fields such as completion rate and last action timestamps, and recomputes feature values that depend on these metrics. The updated feature values are stored for use in future interactions. The input of this step is the structured operation content from the terminal, and the output is a modified set of behavior history records and feature vectors that will influence the construction of subsequent prompt sentences for the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that utilize machine learning or generative AI models are typically designed with fixed visual and auditory configurations for an agent presented to a user. As a result, such systems generally fail to adapt the appearance or voice of the agent to the individual preferences, emotional states, or comfort levels of different users. In many implementations, the user interface is limited to static avatars or pre-defined voice profiles that are not dynamically generated or refined based on user-specific settings, past interaction history, or real-time emotional analysis. This technical limitation can degrade user engagement, reduce the perceived trustworthiness and empathy of the system, and hinder the effectiveness of delivering personalized feedback or action plans.

Moreover, in existing systems, prompts supplied to generative AI models are often constructed in an ad hoc or generic manner, without systematically encoding (i) user-specific configuration parameters for visual and auditory elements of the agent, and (ii) analysis results concerning the user's characteristics and emotional state. As a consequence, the generative AI model may output responses that are not consistently aligned with the user's preferred avatar appearance, voice characteristics, or emotional needs. This inconsistency introduces additional processing overhead on the client side, may require repeated manual adjustments by the user, and leads to inefficient use of computational and network resources, since the system must repeatedly transmit large amounts of configuration data or regenerate media assets without effective reuse of stored user-specific settings.

Furthermore, existing architectures rarely integrate the generation of visual and auditory agent configuration data with the generation of personalized feedback and action plans in a unified server-side pipeline. In many cases, separate subsystems handle avatar rendering, voice synthesis, and dialog content, with minimal coordination. This separation makes it difficult to enforce coherent personalization across modalities, complicates system design, and may increase latency due to redundant data processing and multiple network round trips.

Therefore, there is a need for an improved computer-implemented system and server-side processing technique that: (i) efficiently captures and stores user-specific visual and auditory settings together with interaction history; (ii) automatically generates structured prompt sentences for a generative AI model that encode such user-specific settings and emotional analysis; and (iii) obtains, in a coordinated manner, customized visual element data, auditory element data, and personalized feedback or action-plan data, and applies them to control a terminal device. Such a system should enhance the technical functioning of dialog systems by reducing inconsistent personalization, lowering redundant computation and communication, and enabling more efficient and coherent generation and presentation of multi-modal agent behavior.

The specific processing by the specific processing unit 290 of the data processing device 12 in Example 2 is realized by the following means.

The present invention provides a server comprising a processor and a storage device, the processor being configured to provide, to a terminal device, an interactive screen for receiving, from a user, visual elements and auditory elements for an information processing apparatus; to analyze information including the visual elements and the auditory elements received from the user and store the analyzed information as user-specific setting information in the storage device; to generate a prompt sentence for a generative AI model, the prompt sentence being configured to instruct the generative AI model to (i) evaluate characteristics and an emotional state of the user based on the user-specific setting information and input information from the user, and (ii) generate the visual elements and the auditory elements of the information processing apparatus based on the user-specific setting information; to input the prompt sentence to the generative AI model and obtain, from the generative AI model, visual element data and auditory element data of the information processing apparatus corresponding to the user-specific setting information and data relating to feedback or a personalized action plan for the user; and to control display and audio output on the terminal device so as to display an appearance of the information processing apparatus based on the obtained visual element data and to reproduce a voice of the information processing apparatus based on the obtained auditory element data. This enables an integrated and technically improved personalization pipeline in which user-specific visual and auditory configurations, emotional-state-aware analysis, and generative AI outputs are coherently combined at the server side, thereby reducing redundant processing, improving consistency of multi-modal agent behavior, and enhancing the efficiency and responsiveness of the overall computer-implemented dialog system.

The term “system” refers to an arrangement of one or more computing devices, including at least a server-side processor and one or more terminal devices, that cooperate via one or more communication networks to execute the functions described in the claims.

The term “processor” refers to one or more hardware processing units, such as a central processing unit, a graphics processing unit, or a specialized accelerator, configured to execute instructions and perform the data processing operations described in the claims.

The term “storage device” refers to one or more hardware memory components, such as volatile memory or non-volatile memory, configured to store programs, data, and user-specific setting information used by the processor.

The term “terminal device” refers to a user-operated computing device, such as a personal computer, a tablet device, or a handheld communication device, that communicates with the server and presents visual and auditory information to the user.

The term “user” refers to a human individual or an entity that interacts with the system by providing input information and receiving visual and auditory output through the terminal device.

The term “interactive screen” refers to a graphical user interface presented on the terminal device, including input components such as buttons, sliders, lists, text fields, or other controls, through which the user can input visual elements and auditory elements and receive system feedback.

The term “information processing apparatus” refers to a logical or virtual agent, implemented by hardware and software of the system, that performs data processing and engages in dialog or interaction with the user through visual and auditory presentation on the terminal device.

The term “visual elements” refers to data or parameters defining a visual representation associated with the information processing apparatus, including, for example, avatar style, color scheme, facial expression, layout, or other graphical aspects.

The term “auditory elements” refers to data or parameters defining audio characteristics associated with the information processing apparatus, including, for example, voice pitch, speech rate, intonation, timbre, or other sound-related aspects.

The term “user-specific setting information” refers to information stored for each user, including at least visual elements, auditory elements, and optionally dialog history, preferences, and other configuration data that are used to personalize the behavior and presentation of the information processing apparatus.

The term “input information” refers to information received from the user, including, for example, text input, speech input, selection of options on the interactive screen, and any other data expressing the user's instructions, preferences, or state.

The term “characteristics of the user” refers to attributes of the user inferred or determined by the system, including, for example, behavioral patterns, preferences, communication style, or other user traits derived from the user-specific setting information and the input information.

The term “emotional state of the user” refers to an inferred or estimated mental or affective condition of the user, such as stress, happiness, anxiety, or calmness, determined by analyzing the input information and, optionally, the user-specific setting information.

The term “generative AI model” refers to a computational model, such as a machine-learned generative model, configured to receive a prompt sentence and generate output data, including, for example, text, configuration parameters, or media-related data for visual and auditory elements.

The term “prompt sentence” refers to machine-interpretable text data, including natural-language instructions or structured instructions, generated by the processor and provided as input to the generative AI model to specify a desired processing task or output content.

The term “visual element data” refers to data generated by the generative AI model or derived from its output that concretely specifies visual content or parameters for rendering the appearance of the information processing apparatus on the terminal device.

The term “auditory element data” refers to data generated by the generative AI model or derived from its output that concretely specifies audio content or parameters for reproducing the voice or other sounds of the information processing apparatus on the terminal device.

The term “feedback” refers to information provided by the system to the user in response to the user's input or state, including explanations, guidance, evaluations, or messages tailored to the user.

The term “personalized action plan” refers to a sequence of suggested actions, steps, or strategies generated for the user, where the content and structure of the plan are customized based on the user-specific setting information, characteristics of the user, and emotional state of the user.

The term “display and audio output control” refers to processing performed by the processor to cause the terminal device to render the visual element data on a display and to reproduce the auditory element data through an audio output device, in accordance with the configuration obtained from the generative AI model.

In one embodiment, a server executes a program that realizes the claimed system using general-purpose computing hardware and networked terminal devices. The server includes at least one central processing unit (CPU), such as an x86-64 compatible processor, optional graphics processing units (GPUs) for accelerating neural network inference, and a storage device composed of volatile memory and non-volatile memory. The server runs an operating system such as a general-purpose server operating system, and executes middleware including a web server, an application framework, and a database management system. The server communicates, via a network, with one or more terminal devices operated by users.

A terminal includes a processor, a display, an audio output device such as a speaker or headphones, an input device such as a touchscreen, keyboard, or pointing device, and a network interface. The terminal runs a client application implemented as a web browser or a dedicated application. The terminal renders an interactive screen provided by the server, receives user input specifying visual elements and auditory elements of an information processing apparatus, and outputs visual and audio data generated by the server-side processing.

Server uses specific software modules to perform data processing and data computation. In one embodiment, server uses a web server such as generic HTTP server software to terminate HTTPS connections, an application framework such as a scripting or compiled language framework to implement business logic, and a relational database management system such as a SQL-compliant engine to store user-specific setting information and interaction history. Server further uses a neural network inference engine, for example a library that runs on CPU and GPU, to perform inference for a generative AI model, and optionally uses a text-to-speech engine and an avatar rendering configuration engine.

Server provides, to terminal, an interactive screen rendered using markup and scripting languages (for example, HTML, CSS, and JavaScript in the case of a browser-based implementation). This interactive screen includes graphical controls that allow user to specify visual elements of the information processing apparatus, such as avatar type, color palette, clothing style, facial expression, and layout, and to specify auditory elements such as voice pitch, speech rate, intonation pattern, and timbre preference. Terminal sends these user inputs to server as structured messages via an application programming interface over a network connection.

Server receives the user inputs and performs specific data transformations. Server first parses the incoming data according to a predetermined schema, converts the data into internal data structures such as objects or records, and validates that each field falls within predetermined bounds. For example, server checks that a pitch parameter is within a numeric range that maps to supported frequencies in the text-to-speech engine, and checks that an avatar style identifier corresponds to a row in an avatar configuration table of the database. Server then stores the validated parameters as user-specific setting information in storage. Server uses structured database tables such as a “user_profile” table having columns including a user identifier, one or more avatar configuration fields, one or more voice configuration fields, and timestamps.

Server also stores past dialogue history and other user-provided information. In one embodiment, server stores each dialog turn as a record in a “dialog_history” table, with fields including user identifier, timestamp, user message text, system response text, and metadata such as detected emotional state and context tags. Server may index this table by user identifier and time in order to support efficient retrieval of relevant history for subsequent prompt construction. This structure improves the performance of the system by enabling selective loading of only the necessary subset of history for each interaction, reducing memory consumption and communication load.

Server uses the stored user-specific setting information and recent dialog history to generate a prompt sentence for a generative AI model. In one embodiment, server implements a prompt construction module that concatenates fixed template segments with variable content derived from the stored settings and the latest input. The prompt construction module uses string templates that explicitly encode both: (i) instructions for evaluating user characteristics and emotional state, and (ii) instructions for generating visual element data, auditory element data, and personalized feedback or action plans.

For example, server may generate a prompt sentence such as: “Act as a configuration generator and dialog agent for this user. The user prefers a friendly young person avatar with soft, warm colors and a relaxed posture. Configure the agent's visual appearance accordingly, and configure the agent's voice with slightly low pitch, normal speaking speed, and gentle, reassuring intonation. Evaluate the user's emotional state based on the following recent messages and past interaction context, and generate a personalized feedback and action plan that is supportive and non-judgmental.”

In another example, server may generate a prompt sentence such as: “Generate a JSON-style configuration for an avatar_visual_parameters object and a voice_parameters object for a conversational agent. The avatar should resemble a friendly young adult with casual clothing and a warm smile. The voice should have slightly lower-than-average pitch, moderate speed, and empathetic intonation. Then, based on the user's latest message and emotional cues, propose a step-by-step action plan that helps the user cope with work-related stress, using clear and concise language.”

Although the prompt sentence may request output in a structured form, the prompt itself is generated as plain text and is transmitted as text input to the generative AI model.

Server uses a generative AI model implemented as a neural network, such as a transformer-based language model. In one embodiment, the generative AI model comprises multiple layers of self-attention and feed-forward sublayers, trained on large corpora of text and optionally on structured configuration examples. The model parameters include weight matrices and bias vectors for each layer, learned using a stochastic gradient descent algorithm or a variant such as Adam, with a loss function such as cross-entropy calculated between predicted tokens and target tokens during training. The model may be fine-tuned on domain-specific datasets that include pairs of prompt sentences and desired outputs, where the outputs encode both dialog content and configuration parameters for visual and auditory elements. During training, data augmentation techniques such as paraphrasing, random masking of parameters, and synthetic emotional labels may be applied to increase robustness and generalization.

Server executes the generative AI model on hardware optimized for matrix operations, such as GPUs. The model receives the prompt sentence tokenized into subword units and performs a sequence of matrix multiplications and non-linear transformations to generate probability distributions over output tokens. The server-side inference engine uses beam search or sampling algorithms to produce a sequence of output tokens that represent, for example, a structured configuration description and a natural-language response. This computation is algorithmically distinct from human manual rule-writing; the model learns a complex mapping from high-dimensional input embeddings (including user settings and emotional descriptors) to integrated outputs that jointly encode avatar parameters, voice parameters, and dialog content.

Server performs additional deterministic processing on the output of the generative AI model. When the model outputs a textual description of avatar attributes and voice settings, server applies a parser that extracts key-value pairs for parameters such as avatar_style, color_theme, facial_expression, voice_pitch_level, speech_rate_level, and intonation_profile. Server maps these extracted parameters into concrete resource identifiers stored in separate configuration tables or files. For instance, a “friendly young person” style may map to a specific 2D sprite set or a 3D model file, and a “slightly low pitch” setting may map to numeric values for pitch shifting in a text-to-speech pipeline.

Server uses a text-to-speech engine to generate auditory element data. In one embodiment, server uses a neural TTS system composed of two subnetworks: a sequence-to-sequence model that predicts a mel-spectrogram from text and prosody tags, and a vocoder model, such as a waveform generator based on an autoregressive or flow-based architecture, that converts the mel-spectrogram into a waveform. The TTS engine takes as input the textual content produced by the generative AI model and voice parameters derived from the model's output (e.g., pitch scaling factor, speed factor, and prosody pattern). The engine modifies internal control parameters of the acoustic model and vocoder to realize the requested pitch and tempo. Server then encodes the resulting waveform into a compressed audio format (e.g., a common audio codec) suitable for streaming to terminal. By controlling the TTS parameters at the server side, the system avoids redundant re-generation of similar voices and improves audio consistency across sessions.

Server uses an avatar rendering subsystem to generate or select visual element data. In one variation, server does not generate image pixels for every request, but instead selects from a library of pre-rendered avatar components based on the configuration. The server-side avatar engine may assemble a composite image by layering base body images, clothing layers, and facial expressions, and by applying color transforms. This compositing is performed by graphics libraries running on the server CPU or GPU. In another variation, server uses an image generative model, such as a diffusion model, to generate avatar images from the text description part of the generative AI output. The diffusion model follows a denoising process guided by neural network predictions, and is trained with a mean-squared error loss between predicted and ground-truth noise signals. The server then stores or caches the generated images and provides references or binary data to terminal.

Terminal receives the visual element data and auditory element data. Terminal decodes any compressed image or audio formats and displays the avatar on the display while playing the synthesized voice through the audio output device. Terminal may use graphical APIs such as WebGL or a mobile graphics API to render 2D or 3D avatars, and uses an audio playback API to handle buffering, decoding, and playback synchronization. By offloading heavy neural network computations and compositing tasks to server, terminal reduces local computation and memory usage, enabling consistent behavior across a wide range of terminal hardware.

This overall architecture provides technical improvements beyond simple automation of human tasks. Server maintains user-specific setting information in structured database tables and uses it to generate prompts that jointly condition multiple aspects of the generative AI output. By encoding both personalization parameters and emotional analysis directives into the prompt sentence, server reduces the need for multiple separate calls to independent services and avoids post-hoc patching of inconsistent outputs. This leads to reduced network traffic, because configuration need not be transmitted redundantly with each request, and to improved processing speed, because the generative AI model produces coherent multimodal outputs in a single inference pass.

Furthermore, server implements specific algorithms to analyze user input and infer emotional state. In one embodiment, server employs a separate classifier model, such as a recurrent neural network or transformer encoder, trained on labeled emotional text data. The classifier computes feature vectors representing semantic content and paralinguistic cues (e.g., word choice indicative of stress) and outputs a probability distribution over emotional categories. Server stores the resulting emotional label and a confidence score in dialog history records. When generating new prompt sentences, server includes both the emotional label and the confidence, for example by adding text such as “The user is likely experiencing high work-related stress with high confidence” into the prompt. This structured inclusion of emotional metadata increases the precision with which the generative AI model tailors its feedback and configuration outputs, thereby reducing misalignment and improving response quality.

Server also implements non-conventional control logic for routing and prioritizing processing based on emotional state. For example, when the emotional classifier indicates high stress or distress, server modifies the prompt to shift avatar expression parameters toward more calming appearances and to adjust voice parameters toward slower, softer speech. Server also reorders presentation of content, such that reassuring messages and simpler action steps are presented earlier. This control logic is formulated as rule sets and heuristics applied to structured feature vectors, and is not a simple business rule; it directly determines resource selection and timing at the computer system level, influencing which avatar assets are loaded, which audio parameters are set, and how much dialog history is retrieved for context. As a result, the system reduces cognitive load on the user and avoids unnecessary data fetching, which improves latency and bandwidth usage.

From a machine learning perspective, the generative AI model is trained and used in a way that improves the underlying computer technology. By structuring prompts to include compact representations of user settings and emotional cues, the system reduces the token length needed to express context compared to enumerating full configuration details on every call. This reduces the computational burden on the transformer's attention mechanisms, which scale superlinearly with sequence length. Consequently, inference time decreases and energy consumption on the hardware is reduced. Additionally, by reusing user-specific setting information and limiting changes to deltas relative to stored defaults, server can cache partial model outputs or precompiled avatar and voice configurations, further improving throughput.

In another embodiment, server integrates a model-distillation process. A larger, more capable generative AI model is used offline to generate labeled examples of user-configuration-aware outputs, and a smaller model is trained or fine-tuned to approximate these outputs under constrained resource conditions. During deployment, server selects between the larger model and the smaller model depending on available GPU capacity and latency requirements. This adaptive selection mechanism, coupled with prompt designs that efficiently encode user preferences, yields a better trade-off between accuracy and computational cost than conventional static model selection.

User benefits from the system's ability to maintain continuity across sessions. When user reconnects from the same or a different terminal, server retrieves the user-specific setting information, reconstructs the avatar and voice configuration, and continues the dialog from a consistent state without requiring the user to re-enter preferences. This persistence is achieved through durable storage and indexing techniques within the database, not merely through temporary session variables. Because the prompt sentences and model behavior are conditioned on this stored information, the system preserves personalization in a technically robust manner.

In yet another embodiment, server exposes an application programming interface that allows external applications to request configuration and dialog outputs based on stored user profiles. External applications may pass minimal identifiers and new user messages, and the system internally performs all necessary retrieval, prompt generation, model inference, and media preparation. This separation of concerns and abstraction of internal data structures allow the system to be integrated into heterogeneous computing environments while preserving its technical improvements in computation and communication efficiency.

Through these embodiments, server, terminal, and user cooperate in a concrete technical arrangement in which generative AI model processing, prompt sentence construction, structured data storage, and multimodal media generation are organized into specific modules and data flows. The system thereby achieves improvements in processing speed, personalization accuracy, communication efficiency, and consistent multi-modal presentation, which collectively represent an enhancement of computer technology rather than mere automation of existing human activities.

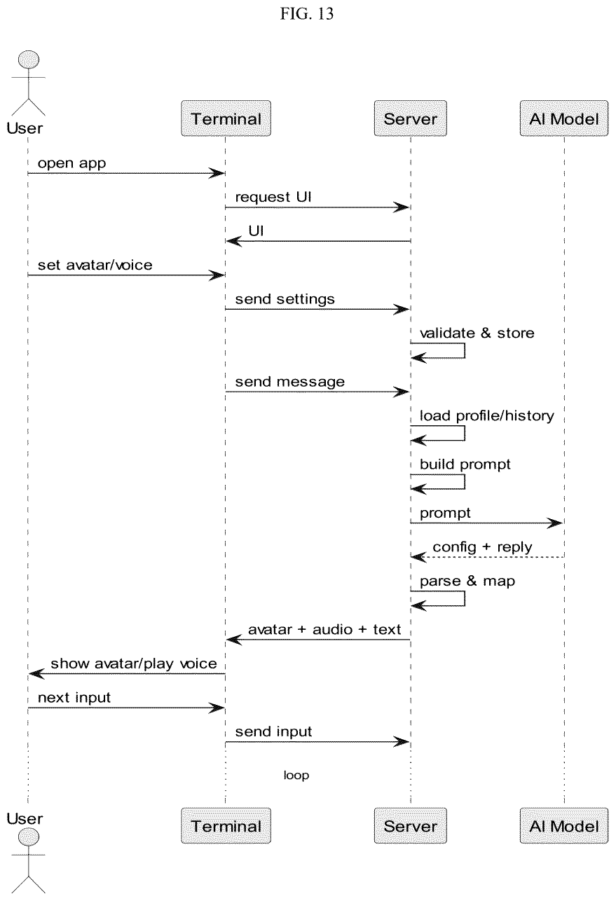

The following describes the processing flow using FIG. 13.

### Step 1:

User operates terminal to start an application or open a web page that connects to server.

Terminal sends an initial request to server to obtain a customization interface. As input, terminal provides at least a user identifier or session token. Based on this input, server retrieves any existing user-specific setting information from storage and generates markup and script data representing an interactive screen. Server outputs this screen data to terminal, which then renders buttons, sliders, and other controls on the display.

### Step 2:

User manipulates the interactive screen on terminal to specify visual elements and auditory elements of an information processing apparatus.

Terminal receives, as input, concrete user actions such as selecting an avatar category, choosing a color theme, and adjusting sliders for voice pitch, speech rate, and intonation. Terminal converts these actions into structured values, for example numerical levels and categorical identifiers, and outputs a structured message (e.g., a parameter set) to server via a network request. The data processing here includes mapping GUI control positions to normalized parameter ranges and packaging them into a defined schema.

### Step 3:

Server receives the structured message from terminal and validates the user-specific settings.

Server takes as input the parameter set containing avatar identifiers, color codes, and voice parameter values. Server performs data checks, including verifying that avatar identifiers exist in an avatar configuration table, color codes match an allowed palette, and voice parameters are within predefined numeric ranges. Server then transforms the validated parameters into internal records and outputs updated user-specific setting information, which it stores in a database keyed by the user identifier. The data processing includes executing database insert or update operations and computing derived fields such as default values for omitted parameters.

### Step 4:

Server retrieves past dialog history and emotional state information for the user.

Server uses the user identifier as input to query dialog history tables and emotional-analysis records in storage. Server filters and sorts records based on timestamps and relevance, and aggregates selected entries into a concise context representation. Server then outputs a context object including recent user messages, system responses, emotional labels, and confidence scores. The data processing includes executing database queries, joining tables, and compressing multiple records into a summarized form that can be embedded in a prompt sentence.

### Step 5:

Server generates a prompt sentence for the generative AI model by combining templates, user-specific settings, and context.

Server takes as input the user-specific setting information (visual and auditory elements) and the context object (dialog history and emotional labels). Server executes a prompt-construction algorithm that selects appropriate template phrases, inserts parameterized descriptions of avatar appearance and voice characteristics, and embeds textual descriptions of the user's emotional state and recent concerns. As data processing, server concatenates strings, replaces placeholder tokens with actual values, and converts structured settings into natural-language phrases. Server outputs a prompt sentence such as:
“Act as a configuration generator and dialog agent for this user. The user prefers a friendly young person avatar with soft, warm colors and a relaxed posture. Configure the agent's visual appearance accordingly, and configure the agent's voice with slightly low pitch, normal speaking speed, and gentle, reassuring intonation. Evaluate the user's emotional state based on the following recent messages and past interaction context, and generate a personalized feedback and action plan that is supportive and non-judgmental.”

### Step 6:

Server sends the prompt sentence to the generative AI model and performs inference.

Server uses the prompt sentence as input, tokenizes the text into subword units, and feeds these tokens into a generative AI model implemented as a multi-layer neural network. The model performs matrix multiplications, attention-weight calculations, and nonlinear transformations on hardware such as GPUs. As a result of this computation, the generative AI model outputs a sequence of tokens that represent structured configuration descriptions (e.g., avatar and voice parameters) and dialog content (e.g., feedback and action plan). Server then detokenizes the output sequence back into text or structured text, and outputs this model-generated text for further parsing.

### Step 7:

Server parses the generative AI model output into configuration data and dialog content.

Server takes as input the text produced by the generative AI model, which may contain labeled segments or syntactic markers indicating avatar_visual_parameters, voice_parameters, and a natural-language response. Server performs text parsing and, if needed, pattern matching or lightweight syntactic analysis to extract key-value pairs for parameters such as avatar style, color theme, facial expression, pitch level, speed level, and intonation type. Server converts these textual descriptions into structured configuration objects and separates the dialog content into a response message and, optionally, a step-by-step action plan. Server outputs two main data structures: a configuration object for visual and auditory elements, and a dialog object for feedback and action plan.

### Step 8:

Server maps configuration objects to concrete media resources and synthesis parameters.

Server uses the configuration object as input to look up actual resource identifiers and numeric control parameters. For visual elements, server queries an avatar asset table or configuration file to determine which image files, 3D models, or style sheets correspond to the requested avatar style, color theme, and expression. For auditory elements, server translates high-level voice descriptors (e.g., “slightly low pitch”) into numeric scaling factors and prosody templates used by a text-to-speech engine. Server performs table lookups, interpolation, and rule-based mapping to derive these concrete values, and outputs media configuration data including file paths, model IDs, pitch and speed modifiers, and prosody profiles.

### Step 9:

Server generates or selects visual element data for the terminal.

Server takes as input the visual media configuration, including avatar asset identifiers and any compositing instructions. In one case, server selects pre-rendered avatar images and, if necessary, uses a graphics library to combine base layers, clothing layers, and expression overlays into a single composite image. In another case, server feeds textual description and parameters into an image-generation model and obtains a new avatar image. Server encodes the resulting image into a display-compatible format and outputs a visual element data package containing either the binary image or a network-accessible location plus rendering metadata.

### Step 10:

Server generates auditory element data by invoking a text-to-speech engine.

Server uses the dialog content (text response) and voice control parameters as input to a neural text-to-speech pipeline. The pipeline first converts text and prosody tags into an intermediate acoustic representation such as a mel-spectrogram, then uses a neural vocoder to synthesize a waveform. Server controls pitch and speed by adjusting input prosody features and vocoder parameters. As output, server obtains an audio waveform, which it then encodes into a compressed audio format suitable for streaming. Server outputs an auditory element data package including the audio data or an accessible resource locator plus playback metadata such as sample rate and expected loudness.

### Step 11:

Server sends combined visual and auditory element data together with dialog content to terminal.

Server takes as input the visual element data package, the auditory element data package, and the dialog object. Server composes a response message that includes references to image or model resources, audio data or URLs, and the text of the feedback or action plan. Server serializes this combined data into a response format and transmits it to terminal via a network. The output of this step is a single structured response that terminal can use to update the user-facing interface in a coordinated manner.

### Step 12:

Terminal receives the response and updates the display to show the customized avatar.

Terminal takes as input the server's response containing visual element data. Terminal downloads or decodes the avatar image or 3D model, and uses its graphical subsystem (for example, a browser rendering engine or a native graphics API) to render the avatar on the display. Terminal may apply layout rules or animation parameters included in the metadata. As output, terminal presents an updated screen in which the avatar's appearance reflects the user-specific settings and the configuration determined by the generative AI model.

### Step 13:

Terminal plays the customized voice and presents dialog content to user.

Terminal uses the auditory element data and dialog text as input. Terminal downloads or decodes the audio stream and invokes an audio playback subsystem to output the synthesized voice through speakers or headphones. Terminal may also display the dialog text as subtitles or chat bubbles synchronized with the audio playback. The output of this step is an audio-visual presentation where the voice characteristics (pitch, speed, intonation) and the visual appearance are consistent with the configuration generated on server.

### Step 14:

User interacts with the personalized information processing apparatus in a continuous dialog.

User provides new input, such as spoken utterances or typed text, in reaction to the displayed avatar and played voice. Terminal captures this input and outputs updated interaction data, including the new user message and current session identifiers, to server. Based on this new input, server repeats the preceding steps of retrieving context, generating a prompt sentence, invoking the generative AI model, and updating configuration and media. In this way, server continually performs data processing and computation that transform user input and stored settings into coherent multimodal outputs, while terminal renders and plays them to user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog systems that utilize machine learning or rule-based engines typically treat user input as a flat text stream and generate responses in a one-size-fits-all manner. Such systems generally lack a robust mechanism to (i) accurately evaluate user-specific characteristics and emotional state in real time, (ii) translate that evaluation into precise and controllable prompt sentences for a generative AI model, and (iii) coordinate the generated textual response with a dynamically customized visual and audio representation of a virtual entity. As a result, the system's behavior is often opaque and brittle: small changes in user input can lead to unstable or inappropriate responses, and the user experience remains generic and insufficiently adaptive.

Furthermore, existing architectures commonly separate text generation from presentation logic. A back-end model may produce text, while a front-end independently renders an avatar or plays audio with static settings. This fragmentation prevents the system from using emotional and contextual analysis to drive both the content and the form of the response in a unified, programmable way. For example, the system cannot reliably adjust a virtual entity's tone, appearance, or timing of output based on a quantified emotional index or historical dialogue context. This leads to inefficient use of computational resources, difficulty in debugging model behavior, and limited controllability of generative AI output in safety-critical or sensitivity-critical domains such as mental health support or security consultation. Additionally, many conventional systems provide only coarse-grained “style” controls for generative models and do not expose a structured, processor-level mechanism for constructing prompt sentences that consistently encode user characteristics, emotional indices, and past interaction records. Without such a mechanism, it is difficult to ensure reproducible and verifiable behavior of the generative AI model across sessions, or to prioritize processing and routing based on the detected emotional state. Consequently, the underlying computer technology does not fully exploit contextual and emotional information to optimize response generation and presentation, and cannot sufficiently improve system-level performance, controllability, and user trust.

Accordingly, there is a need for an improved computer-implemented system in which a processor (i) systematically analyzes user input to extract feature information representing user characteristics and emotional state, (ii) constructs structured prompt sentences for a generative AI model based on both current input and stored dialogue context, (iii) manages customization settings for a virtual entity's visual and audio expression, and (iv) controls processing order, output format, and routing based on an emotional index. By tightly integrating these functions at the processor level, the system can improve the technical operation of dialog processing, enabling more stable, context-aware, and resource-efficient interactions with generative AI models.

The specific processing by the specific processing unit 290 of the data processing device 12 in Application Example 2 is realized by the following means.

The present invention provides a server comprising a processor configured to provide, to an information input/output apparatus, a user interface for receiving information from a user, to analyze text data or voice data acquired from the user by natural language processing or emotion analysis to extract feature information representing characteristics and an emotional state of the user, to construct a prompt sentence for a generative AI model, the prompt sentence being configured to instruct the generative AI model to propose feedback or a personalized action plan to the user based on the extracted feature information and a dialogue context of the user, to input the constructed prompt sentence into the generative AI model and generate, as feedback information, a response sentence obtained from the generative AI model, to manage customization settings for at least one of a visual expression and an audio expression corresponding to the feedback information in accordance with appearance parameters and voice parameters received from the user and to generate, based on the customization settings, a visual expression and an audio expression of a virtual entity, and to output the visual expression and the audio expression of the virtual entity to the information input/output apparatus and present the feedback information to the user through the virtual entity. This enables the underlying computer system to tightly couple contextual and emotional analysis with prompt construction and multimodal rendering, thereby improving the technical operation of dialog processing by producing more stable, controllable, and user-adaptive interactions with the generative AI model, reducing unintended model behavior, and allowing processing order, output format, and routing to be dynamically optimized based on quantified emotional state and dialogue history.

The term “processor” refers to a hardware processing unit or a combination of hardware processing units configured to execute computer-readable instructions and to perform logical and arithmetic operations required to implement the functions of the system.

The term “information input/output apparatus” refers to an electronic device that provides an interface for a user to input information to, and receive information from, the system, and that includes at least one of a display device, a pointing device, a touch panel, a microphone, a speaker, or a camera.

The term “user interface” refers to a software-controlled presentation and control layer that is displayed or presented on the information input/output apparatus and that enables a user to input information, adjust settings, and receive output from the system.

The term “text data” refers to character-based information representing user input, including but not limited to natural language sentences, phrases, or symbols, that can be processed by the processor using text-based algorithms.

The term “voice data” refers to audio information representing spoken user input, including digitized sound waveforms or encoded audio streams, that can be processed by the processor for speech recognition, emotion analysis, or playback.

The term “natural language processing” refers to a group of computational techniques executed by the processor for analyzing and processing human language expressions, including at least one of tokenization, part-of-speech tagging, syntactic parsing, semantic analysis, sentiment analysis, and named-entity recognition.

The term “emotion analysis” refers to a processing operation in which the processor evaluates user input, including text data or voice data, to estimate an emotional state of the user, such as anxiety, sadness, joy, or anger, and to output a corresponding emotion label, score, or index.

The term “feature information” refers to structured data derived from user input by analysis, and representing at least one of user characteristics, user preferences, user behavioral tendencies, and an emotional state of the user, which is used by the processor as a basis for subsequent processing.

The term “user characteristics” refers to attributes associated with the user, including at least one of demographic information, skill level, personality traits, past behavior patterns, or stated preferences, which are used by the processor to personalize processing.

The term “emotional state” refers to a psychological condition of the user at a particular time, inferred from user input, and represented as at least one of a categorical label, a continuous score, or a multi-dimensional vector indicating affective dimensions.

The term “dialogue context” refers to accumulated information related to an interaction session with the user, including at least one of past user inputs, past system responses, timestamps, and session metadata, which is used by the processor to interpret current input and construct prompt sentences.

The term “generative AI model” refers to a machine-learned computational model that generates output information, including natural language text, in response to input information, and that is based on statistical or neural network techniques trained on large datasets.

The term “prompt sentence” refers to an input expression constructed by the processor for the generative AI model, the input expression including at least an instruction part and a context part, and being configured to control a task, style, or content of output generated by the generative AI model.

The term “feedback information” refers to information generated for the user based on a response produced by the generative AI model, including at least one of explanations, suggestions, confirmations, or inquiries, and optionally being post-processed by the processor.

The term “personalized action plan” refers to a set of one or more recommended actions generated for a specific user based on the user's characteristics, emotional state, and context, the set including at least a sequence or grouping of suggested steps.

The term “visual expression” refers to a visual output element presented on the information input/output apparatus, including at least one of an avatar, an animation, a graphical symbol, or a layout effect, that represents or accompanies the feedback information.

The term “audio expression” refers to an audio output element presented via the information input/output apparatus, including at least one of synthesized speech, sound effects, or background sounds, that represents or accompanies the feedback information.

The term “virtual entity” refers to a software-generated representation controlled by the processor, including at least a visual expression and/or an audio expression, that functions as an apparent interlocutor or agent when interacting with the user.

The term “appearance parameters” refers to configuration values specifying attributes of the visual expression of the virtual entity, including at least one of avatar type, color scheme, posture, animation style, or facial expression profile.

The term “voice parameters” refers to configuration values specifying attributes of the audio expression of the virtual entity, including at least one of voice type, pitch, speaking rate, volume, prosody pattern, or timbre characteristics.

The term “customization settings” refers to data representing at least one of the appearance parameters and the voice parameters chosen or adjusted for the virtual entity, and stored or managed by the processor for use in generating output for the user.

The term “storage device” refers to a hardware component or a combination of hardware components configured to store data persistently or semi-persistently, including at least one of a semiconductor memory, a magnetic storage unit, or an optical storage unit.

The term “past dialogue history” refers to stored records of previous exchanges between the user and the system, including user inputs and system outputs associated with timestamps or session identifiers, which are retrievable by the processor.

The term “user attribute information” refers to stored data describing properties of the user, including at least one of profile information, preference settings, permission levels, or device usage patterns, which may be used by the processor to adapt system behavior.

The term “index indicating the emotional state” refers to a quantitative or symbolic indicator computed by the processor that represents the emotional state of the user, including at least one of a numerical score, a vector representation, or a discrete category.

The term “processing order” refers to a priority or sequence in which the processor performs operations related to one or more user requests, including scheduling of analysis, generation, routing, and output steps.

The term “output format” refers to a presentation form determined by the processor for delivering feedback information, including at least one of text-only format, audio-only format, audiovisual format, or format with enhanced emphasis or reduced detail.

The term “processing apparatus” refers to a computing subsystem, separate from or in addition to the processor of the server, that is capable of receiving and processing information, and that may include another server, a client device, or a specialized computing module.

The term “responsible department” refers to an organizational or logical unit to which certain categories of feedback information are directed, including at least one of a support team, a counseling service, an escalation unit, or an automated service module.

In one embodiment, a server, a plurality of terminals, and a data communication network together implement the claimed system. The server includes at least one processor, a main memory, a non-volatile storage device, and a network interface. The server executes an operating system and middleware for providing web services or application programming interfaces. The terminals include, for example, a smartphone, a tablet, a head-mounted display, or a personal computer, each having a display, an input device such as a touch panel, a microphone, a speaker, and optionally a camera. The terminals execute a client program, such as a native application or a web browser running client-side scripts.

The server executes a plurality of software modules including a user interface management module, a natural language processing module, an emotion analysis module, a generative AI orchestration module, a prompt construction module, a visual/audio customization management module, a virtual entity rendering control module, and a data storage management module. The server stores user attribute information, past dialogue history, customization settings, and precomputed model parameters on the non-volatile storage device.

The terminal presents a user interface generated by the user interface management module. The terminal displays input fields for text, graphical controls for selecting an avatar type, and sliders or selection components for adjusting voice parameters such as pitch and speaking rate. The terminal also provides buttons for submitting user input and for starting or stopping voice-based interaction. The terminal receives user operations and converts the operations into structured data, which include at least a user identifier, current input text or voice data, and customization parameters. The terminal transmits the structured data to the server via the network interface using a predetermined communication protocol.

The server receives text data or voice data from the terminal and stores the data temporarily in memory. When the server receives voice data, the server optionally uses a speech recognition engine to convert the audio waveform into text data, for example by applying a recurrent neural network or transformer-based acoustic model and a language model for decoding. The server then passes the resulting text data to the natural language processing module. The natural language processing module uses a language processing library, such as a tokenization and part-of-speech tagging toolkit, to segment the text into tokens, to assign part-of-speech tags, and to build a syntactic dependency tree. The server uses this structured representation to identify key phrases, named entities, and grammatical relations. For example, the server identifies phrases such as “work relationships,” “comfortable running shoes,” or “home Wi-Fi security” as domain-specific terms to be preserved and highlighted in subsequent processing.

The server further uses the emotion analysis module to estimate an emotional state from the text data. The emotion analysis module applies a classifier, for example a neural network with an embedding layer, multiple bidirectional recurrent layers, and a dense output layer that produces a probability distribution over emotion categories such as “anxiety,” “sadness,” “stress,” or “joy.” The classifier is trained on a labeled dataset of text segments with emotion labels. During training, the server minimizes a cross-entropy loss function between the predicted distribution and the ground truth label, and the server updates network weights with a stochastic gradient descent method or an adaptive optimizer. In deployment, the server uses the trained network to compute, for each user message, an index indicating the emotional state, such as “anxiety: 0.82.” The server stores the index, along with the text and timestamp, in a dialogue context data structure maintained in memory and persisted to the storage device. The server structures the dialogue context as a sequence of message records, each record including at least a role field (user or system), a timestamp field, a text field, an optional emotion index field, and an optional reference to customization parameters in effect at the time. The server uses this sequence as input to the prompt construction module. The prompt construction module generates a prompt sentence for a generative AI model. The prompt sentence includes, for example, (i) a role description, (ii) a summary of relevant dialogue context, (iii) the latest user input, and (iv) explicit behavioral constraints. The server concatenates these parts into a single natural language string.

By way of example, when a user expresses work-related stress, the server constructs a prompt sentence such as: “The user wrote: ‘Recently, work relationships are exhausting and I feel anxious every day.’ Detected emotion: anxiety (high). You are a non-judgmental, supportive AI listener. Respond in English with empathy, avoid giving any medical or diagnostic statements, acknowledge the user's feelings, and ask one gentle follow-up question to better understand the situation.”

When a user provides a shopping-related query for a virtual store, the server constructs a prompt sentence such as:
“You are a calm adult female AI store clerk. The user said: ‘I am looking for comfortable running shoes.’ Use a friendly and concise tone. Ask two clarifying questions about preferred price range and running frequency, and then suggest possible product categories without making strong sales pressure.”

When a user expresses a security concern, the server constructs a prompt sentence such as:
“The user wrote: ‘Recently, I'm worried that my home Wi-Fi might be easy to hack.’ Topic: home network security. Respond in an empathetic and non-judgmental tone. First, acknowledge the user's concern. Then ask one or two simple questions about their router configuration and password usage, and suggest only basic, safe first steps. Do not ask for any personal identifiers or confidential information.”

The server passes the constructed prompt sentence to the generative AI orchestration module. The generative AI orchestration module interfaces with a generative AI model, for example a large language model implemented as a transformer neural network with multiple self-attention layers, feed-forward sublayers, layer normalization, and residual connections. The model is pre-trained on large corpora and optionally fine-tuned on domain-specific conversational datasets. During fine-tuning, the server uses training prompts and target responses, computes a sequence-level loss over predicted tokens, and updates model parameters by backpropagation.

In operation, the server transmits the prompt sentence and model parameters or model identifiers to the generative AI model. The generative AI model processes the prompt sentence by generating context-aware token embeddings, performing attention over the token sequence, and computing probability distributions over possible next tokens. The server samples or decodes the token sequence using specific decoding parameters such as temperature, top-k, or top-p. The server stores the generated token sequence in memory and converts it to a response sentence in string form.

The server implements additional control logic to ensure that the behavior of the generative AI model is technically improved compared to generic usage. The server enforces length limits, filters disallowed content, and optionally re-invokes the generative AI model with modified prompt sentences when the generated response does not satisfy certain criteria. For example, the server uses a classification model to detect whether the output violates constraints specified in the prompt sentence. If the output is inconsistent, the server automatically adjusts the prompt sentence by inserting additional constraints or clarifications and resubmits the modified prompt sentence, thereby reducing the probability of unwanted or unstable model behavior and improving the reliability and reproducibility of responses at the system level.

The server transforms the raw response sentence into feedback information linked to multimodal presentation parameters. The visual/audio customization management module maintains customization settings obtained from the user. The server stores appearance parameters such as avatar type, body proportions, color palette, and animation style, as well as voice parameters such as voice type, pitch, speaking rate, volume, and prosody pattern. The server associates each set of customization settings with a user profile or a session identifier in the storage device. When the server generates feedback information, the virtual entity rendering control module retrieves the relevant customization settings and encodes them into rendering instructions.

The server cooperates with a visual rendering engine and a voice synthesis engine to realize the visual and audio expressions of the virtual entity. For the visual expression, the server can use a 3D graphics engine executing on the server or on the terminal. The server selects a 3D model file, such as a model created in a 3D content creation tool and stored in a standardized mesh format, and chooses an idle animation, a talking animation, and optional gesture animations. The server generates a set of rendering control parameters, including model identifiers, animation identifiers, camera positions, lighting settings, and animation timing synchronized with text segments. The server transmits these control parameters to the terminal, which drives a graphics processing unit to render the visual expression frame by frame.

For the audio expression, the server uses a speech synthesis engine, such as a neural text-to-speech system. The server passes the response sentence and voice parameters to the speech synthesis engine. The speech synthesis engine uses an acoustic model and a vocoder, for example a sequence-to-sequence model with attention and a neural waveform generator.

During training of the acoustic model, the server optimizes a loss function that measures the difference between predicted acoustic features and ground truth spectrograms. During inference, the server converts the response sentence into phonetic or character sequences, generates a mel-spectrogram, and then synthesizes waveform samples. The server obtains audio data, stores the data in a file or a memory buffer, and sends a reference to the terminal.

The terminal receives the visual rendering parameters and the audio data reference. The terminal loads the specified 3D model and animations into a local rendering engine, maps the animations to states such as idle and speaking, and plays the animations in synchronization with the playback of the audio data. The terminal thus presents a virtual entity that appears to speak the generated response sentence with a user-selected appearance and voice characteristics. This integrated control of visual and audio expressions is performed using specific control signals derived from the prompt sentence, the dialogue context, and the emotion indices, rather than merely displaying text. As a result, the system improves the way in which the computer utilizes graphical and audio hardware resources to realize a coherent, context-aware interaction.

The server further uses the emotion index to control processing order and routing decisions. When the emotion analysis module outputs an index indicating a high level of negative emotion, such as a high value for “anxiety” or “distress,” the server increases the priority of processing the corresponding request. The server adjusts an internal priority queue and schedules the execution of the natural language processing, prompt construction, generative AI invocation, and rendering control before lower-priority tasks. This priority scheduling reduces response latency for high-emotion cases and therefore improves the timeliness and technical quality of interaction for those cases, beyond mere business workflow optimization. The server additionally routes certain feedback information to external processing apparatuses when the emotion index exceeds a threshold, for example routing to a specialized support subsystem, while still controlling the format and timing of such routing through the same technical framework.

The described architecture yields technical effects in several ways. By encoding emotion indices and dialogue context into structured prompt sentences, the server reduces the need for repeated trial-and-error prompt engineering at runtime and produces more stable output distributions from the generative AI model. By consistently constructing prompt sentences with explicit role and constraint information, the server narrows the effective search space of generated tokens and reduces the number of iterations needed to obtain a suitable response. This reduces computation load on the generative AI model, decreases network traffic between the server and the model, and improves overall throughput.

Moreover, the integration of customization settings into the rendering control pipeline reduces redundant computations on the terminal. Since the server precomputes and sends parameterized rendering instructions, the terminal avoids unnecessary resource-intensive operations such as reloading models or reconfiguring shaders for each interaction. This lowers GPU load and contributes to smoother real-time rendering. The system improves data management by storing dialogue context and customization settings in structured, indexable data structures, which allow efficient retrieval and update operations using indexed queries rather than scanning raw logs.

The server uses algorithms and data structures that are not mere automation of human reasoning. For example, the emotion analysis module applies a high-dimensional embedding of token sequences and performs classification in embedding space, which is not a human-conductible step-by-step inference. The prompt construction module uses rule sets that incorporate both symbolic constraints and quantitative features such as emotion scores and recency weights. The server may, for instance, calculate a recency-weighted context vector and use it to decide which part of the dialogue history to include in the prompt sentence. This procedure improves the relevance of context and prevents the generative AI model from being overloaded with redundant information, thereby enhancing both response accuracy and computation efficiency.

In another embodiment, the server adjusts hyperparameters of the generative AI model dynamically based on the emotion index and message length. For highly sensitive emotional content, the server sets generation parameters to reduce randomness and to favor conservative outputs. For neutral content, the server allows a higher degree of variation. This adaptive parameter control is computed algorithmically and yields technical benefits: it reduces the incidence of inappropriate content, decreases the need for additional filtering passes, and thus improves the computation and communication efficiency of the entire pipeline.

In a further embodiment, the server segments long user messages into semantically coherent units using a segmentation algorithm applied to the dependency tree and punctuation markers. The server constructs separate prompt segments and combines the generated partial responses while preserving a coherent overall response. This segmentation algorithm improves memory usage of the generative AI model and prevents token overflow, resulting in higher robustness and reduced latency when processing long inputs.

In another embodiment, multiple generative AI models are used. The server selects a specific generative AI model instance based on detected domain, such as a counseling domain, a shopping assistance domain, or a security domain. The server maintains a model registry and selects models according to domain-specific performance metrics stored in the registry. The server, for example, uses a first model fine-tuned on counseling data and a second model fine-tuned on product recommendation data. The server chooses the model by evaluating classification scores from the natural language processing module. This selection mechanism improves accuracy and reduces the number of tokens that must be generated or post-processed.

In yet another embodiment, the server or the terminal performs caching of visual and audio assets keyed by customization settings. When the server generates an identical or similar combination of avatar appearance and voice parameters, the system reuses cached assets instead of recomputing them. This caching algorithm uses hash values of customization settings to detect reuse opportunities. Such reuse reduces rendering preparation time and bandwidth consumption, resulting in faster and smoother user experiences, particularly in resource-constrained environments.

Although the embodiments described above refer to particular arrangements of modules and example prompt sentences, variations are possible. The server may employ different neural network architectures for emotion analysis, such as convolutional networks or transformers, alternative loss functions, or alternative optimization algorithms, without departing from the core concept of extracting feature information, constructing structured prompt sentences, managing customization settings, and controlling rendering and routing in response to quantified emotional indices. The terminals may employ different display technologies or audio playback chains, and the communication protocol may be adapted to different network environments, as long as the server and the terminals cooperate to implement the functions recited in the claims.

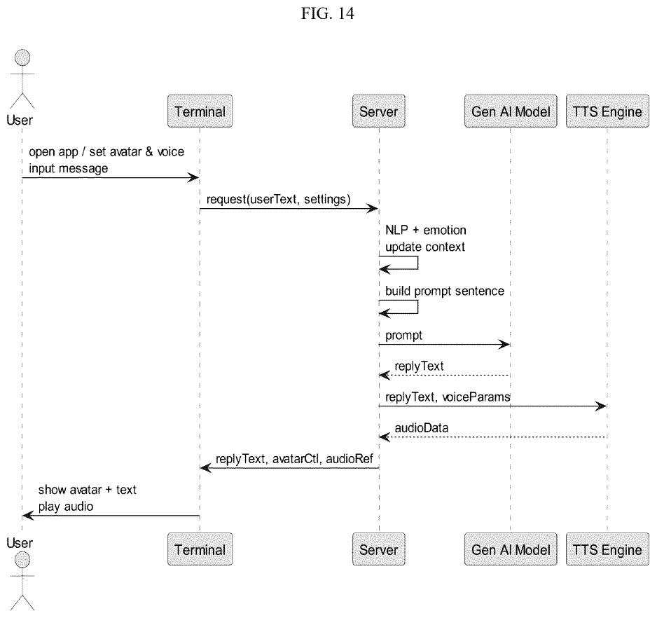

The following describes the processing flow using FIG. 14.

### Step 1:

User operates the terminal to launch the application and open the dialog screen.

User taps an application icon or inputs a URL so that the terminal loads a dialog interface.

Input: No application-specific data is yet provided by the user.

Output: The terminal presents an initial user interface that includes text input fields, avatar selection controls, and voice parameter sliders.

Terminal initializes internal data structures for user ID, session ID, and default customization settings, and displays the interface on the display device.

### Step 2:

User provides initial input and customization settings via the terminal.

User types or speaks an initial message (for example, “Recently, work relationships are exhausting and I feel anxious every day.”), and selects one avatar type and one set of voice parameters (for example, “calm adult female,” low pitch, normal speed).

Input: Raw user operations, including keystrokes, touch events, and optionally audio signals captured by a microphone.

Output: Structured request data including at least a user identifier, session identifier, text data (or audio data), avatar parameters, and voice parameters.

Terminal converts key and touch events into a character string, optionally invokes a speech recognition engine to convert audio into text, and constructs a data object that encapsulates the text string and customization parameters.

### Step 3:

Terminal transmits the structured request data to the server over the network.

Terminal establishes an encrypted connection and issues a request message containing the user's text data and customization settings.

Input: Structured request data generated in Step 2.

Output: A network message compliant with a predetermined application protocol, transmitted to the server's network interface.

Terminal serializes the structured data (for example, into a JSON or binary format), attaches a session identifier and authentication token, and sends the serialized data to a predefined endpoint of the server.

### Step 4:

Server receives and validates the request data from the terminal.

Server reads the network message from the network interface, checks integrity, and parses the payload.

Input: Serialized request data received over the network.

Output: Parsed request object containing the user text, avatar parameters, voice parameters, and metadata such as timestamps and user identifiers.

Server performs data parsing operations to reconstruct the request object from the serialized format, verifies that required fields are present and conform to expected types, and logs the request header for traceability.

### Step 5:

Server applies natural language processing to the user text data.

Server passes the text portion of the request object to a natural language processing module.

Input: User text string such as “Recently, work relationships are exhausting and I feel anxious every day.”

Output: Linguistic features including token list, part-of-speech tags, syntactic dependency structure, and identified key phrases or entities.

Server tokenizes the text into words and punctuation, applies a part-of-speech tagging algorithm, builds a dependency tree, and detects phrases like “work relationships” and “feel anxious” as important semantic units; these features are stored in memory for subsequent processing.

Step 6:

Server performs emotion analysis on the user input.

Server forwards the processed text or raw text to an emotion analysis module.

Input: User text string and optional linguistic features from Step 5.

Output: An emotion index consisting of at least one emotion label (for example, “anxiety”) and an associated confidence score or intensity value (for example, 0.82).

Server encodes the text into numerical vectors using an embedding layer, propagates the vectors through a trained neural classifier (for example, a recurrent or transformer-based model), computes a probability distribution over emotion categories, and selects the highest probability emotion as the label; server then stores the label and score in a dialogue context record.

### Step 7:

Server updates the dialogue context with the new input and emotion index.

Server appends a new record to an internal context structure that represents the dialog history.

Input: Parsed request object, linguistic features, and emotion index generated in Steps 5 and 6.

Output: Updated dialogue context that includes the new user message record with role information, timestamp, emotion index, and references to customization settings.

Server creates a message record with fields such as role=“user,” text=user's message, emotion=computed label and score, and session ID; server appends this record to a context list or database table, enabling efficient retrieval based on session and recency.

### Step 8:

Server constructs a prompt sentence for the generative AI model.

Server uses the updated dialogue context, user characteristics, and emotion index to generate a control string for the generative AI model.

Input: Dialogue context from Step 7, user attributes stored in a database, and emotion index.

Output: A prompt sentence that includes a role description, relevant historical snippets, the latest user input, and explicit behavioral instructions.

Server selects a subset of recent messages, summarizes if necessary, and concatenates these with a role description (for example, “non-judgmental, supportive AI listener”) and constraints (“avoid medical diagnoses, ask one gentle follow-up question”); server then forms a single coherent prompt sentence such as:
“The user wrote: ‘Recently, work relationships are exhausting and I feel anxious every day.’ Detected emotion: anxiety (high). You are a non-judgmental, supportive AI listener. Respond in English with empathy, avoid giving any medical or diagnostic statements, acknowledge the user's feelings, and ask one gentle follow-up question to better understand the situation.”

### Step 9:

Server sends the prompt sentence to the generative AI model and obtains a response.

Server invokes a generative AI model interface, providing the constructed prompt sentence and decoding parameters.

Input: Prompt sentence from Step 8 and configuration parameters such as maximum token count, temperature, and sampling strategy.

Output: Generated response text that forms the basis of feedback information to the user.

Server encodes the prompt sentence as a sequence of tokens, transmits the tokenized sequence and model selection information to the generative AI model, waits for the generated output token sequence, and decodes the tokens back into a natural language string; server may perform a verification pass that checks length and basic content compliance before accepting the result.

### Step 10:

Server integrates the response text into the dialogue context as system feedback.

Server records the generated response and associates it with the session and customization settings.

Input: Generated response text from Step 9 and current dialogue context.

Output: Updated dialogue context containing a new system message record, and a finalized feedback information object ready for multimodal rendering.

Server creates a new message record with role=“system,” text=generated response, timestamp, and a reference to the emotion index used during generation; server stores this record and encapsulates the response text into a feedback object that will be linked to visual and audio expressions.

### Step 11:

Server prepares visual customization instructions for the virtual entity.

Server retrieves appearance parameters from the request and stored customization settings.

Input: Feedback information object from Step 10 and appearance parameters such as avatar type, color profile, and animation style.

Output: Visual control data that specify which 2D or 3D assets to use and how to animate them during feedback presentation.

Server selects a visual asset set corresponding to the chosen avatar type, generates a configuration that includes model identifiers, animation states (for example, idle and speaking gestures), and synchronization markers aligned with response segments, and stores these control parameters in a structure suitable for transmission to the terminal.

### Step 12:

Server generates or triggers audio expression based on the response text and voice parameters.

Server passes the response text and selected voice parameters to a speech synthesis engine.

Input: Response text from Step 9 and voice parameters such as pitch, speaking rate, and voice type obtained from the request.

Output: Audio data or an audio resource identifier representing synthesized speech that pronounces the response text.

Server encodes the text into phonetic or linguistic units, invokes a neural text-to-speech engine that converts the units into acoustic features and then into waveform samples, receives the synthesized audio stream, stores it on a storage device, and generates a reference (for example, a file path or resource ID) for later retrieval by the terminal.

### Step 13:

Server assembles a multimodal response package and sends it to the terminal.

Server combines text, visual control data, and audio resource identifiers into a single response object.

Input: Feedback information, visual control data from Step 11, and audio reference from Step 12.

Output: A structured multimodal response message transmitted to the terminal, including the response text, visual instructions, and audio reference.

Server embeds the generated response text, avatar configuration, animation mapping, and audio resource identifier into a data object, serializes the object into a transport format, and sends it via the network interface to the terminal associated with the user's session.

### Step 14:

Terminal receives the multimodal response and prepares for presentation.

Terminal reads the response message and parses the included components.

Input: Multimodal response message from Step 13.

Output: Local data structures for text display, visual rendering, and audio playback that are synchronized according to the control information.

Terminal deserializes the message, extracts the response text, determines which avatar model and animations to load, and fetches the audio data from the indicated resource, either by downloading it or by reading it from a local cache.

### Step 15:

Terminal renders the virtual entity and outputs the feedback to the user.

Terminal drives the display and audio hardware to present the response through the customized virtual entity.

Input: Parsed visual control data, response text, and audio data prepared in Step 14.

Output: A synchronized audiovisual presentation on the terminal that includes the avatar motion and spoken response, as well as optional on-screen display of the text.

Terminal loads the designated 2D or 3D avatar assets into a graphics engine, applies the specified animation states, starts audio playback of the synthesized speech through speakers or headphones, and coordinates the timing so that the avatar lip movements or gestures align with the audio; terminal also displays the response text in a chat bubble or subtitle area.

### Step 16:

User perceives the multimodal feedback and optionally continues the interaction.

User reads the text, listens to the voice, and may decide to input further messages or adjust customization settings.

Input: Audiovisual feedback presented on the terminal.

Output: New user operations, such as additional text input, voice input, or changed appearance and voice parameters, which re-enter the processing flow at Step 2.

User interprets the content and may refine the question or provide additional details, allowing the system to iteratively update dialogue context, emotion indices, prompt sentences, and generative AI model responses in subsequent cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

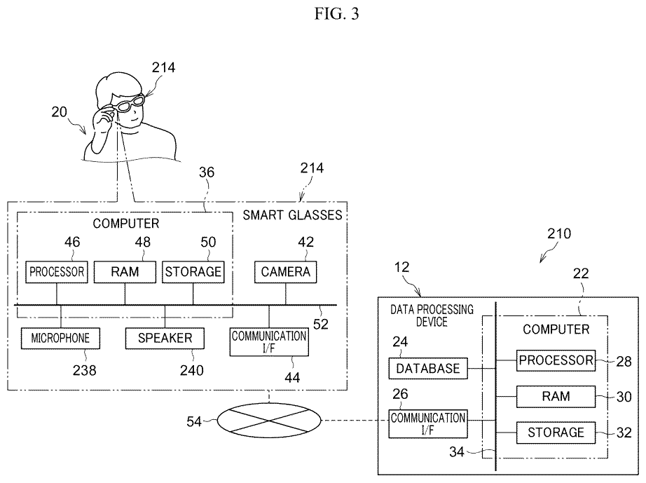

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

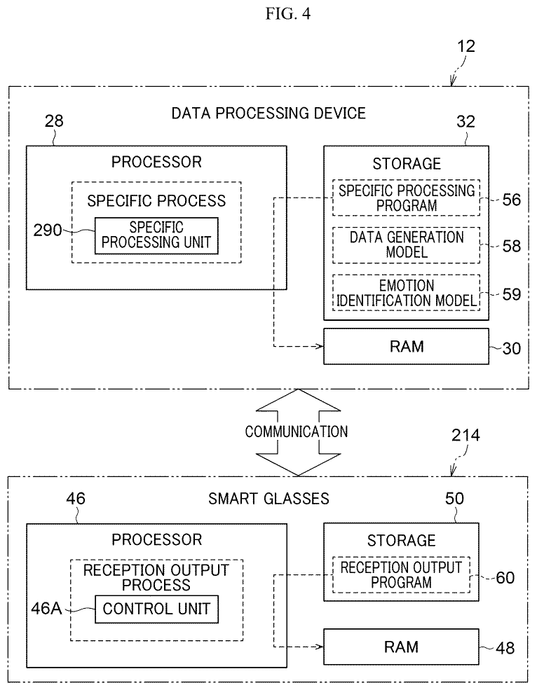

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

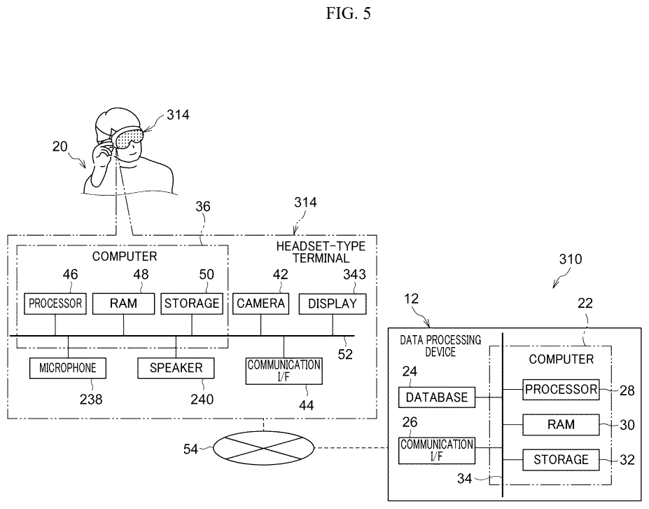

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

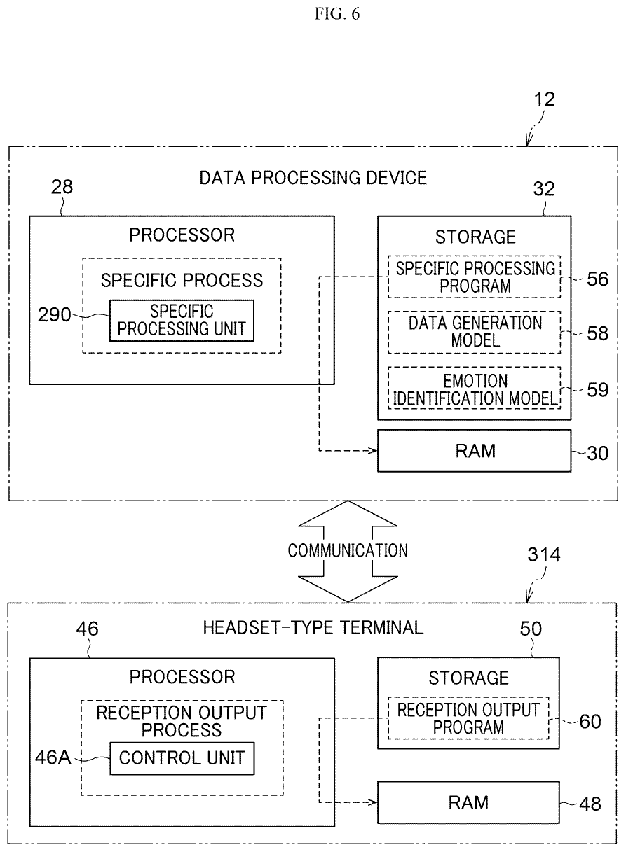

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

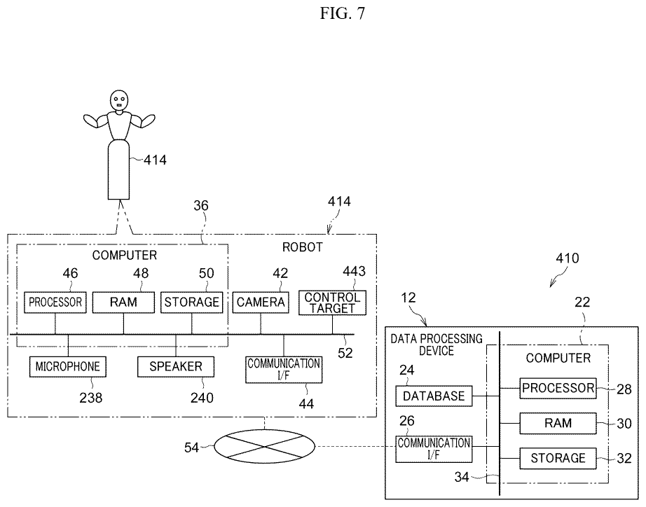

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

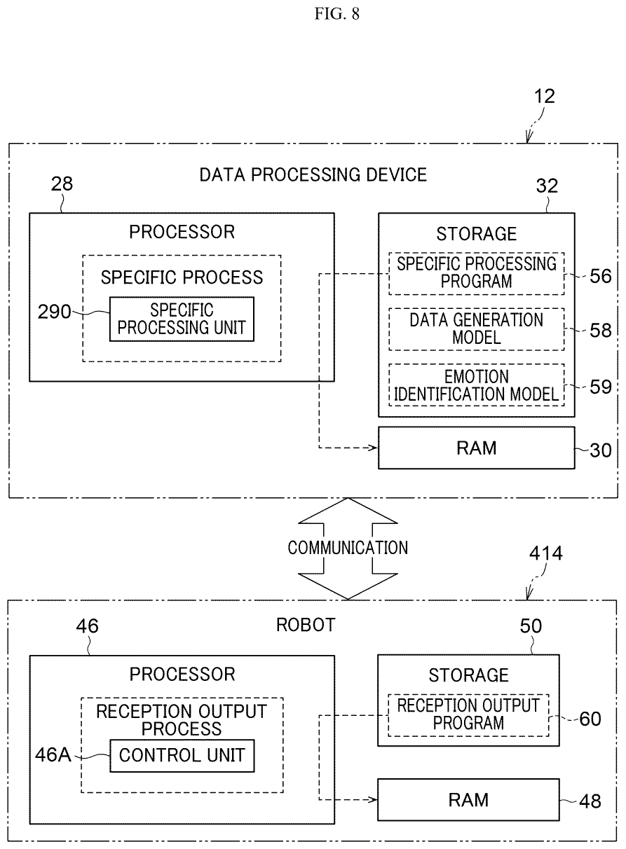

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

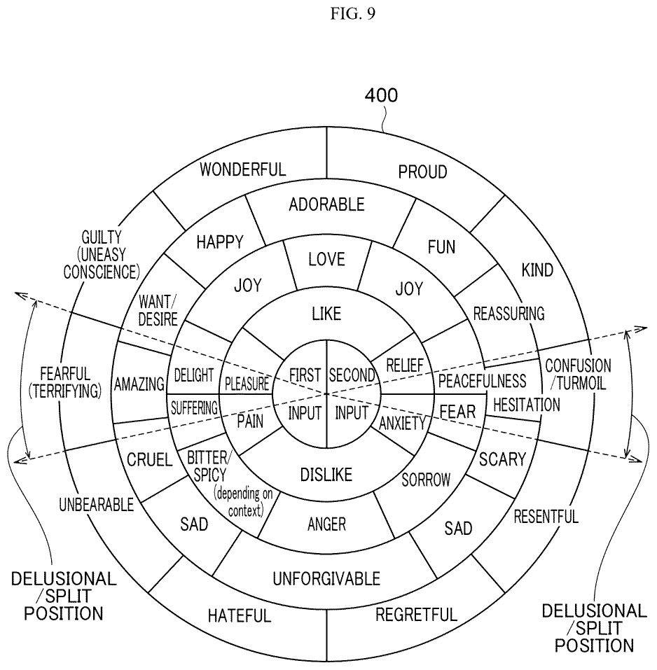

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

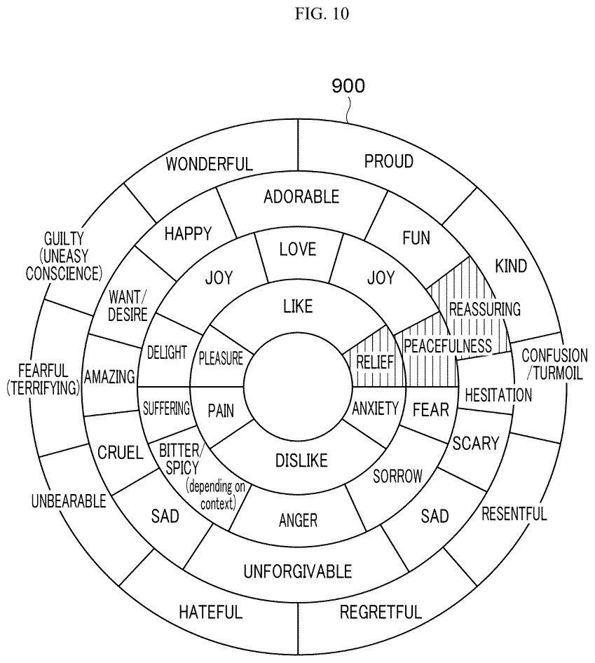

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide, via a display device and an input device of an information processing device, an interactive screen for receiving voice information or character information from a user,
convert the voice information into character information by using a speech recognition program, generate dialogue data including the character information and user identification information, and transmit the dialogue data via a communication path by using a transmission unit,
retrieve, on the basis of the user identification information, user attribute information, skill information, personality information, current situation information, and past dialogue history information stored in a storage device, and generate context information by integrating the dialogue data and the retrieved information,
generate, on the basis of the context information, a prompt sentence including at least a role instruction for a system, the user attribute information, the past dialogue history information, and current user input information, by executing character string manipulation processing, and convert the prompt sentence into input data for input to a generative AI model,
input the input data to the generative AI model and cause the generative AI model to generate, by executing numerical operations including matrix operations and an attention mechanism, generated text including response information and individualized action plan information for the user,
perform content safety determination processing and format shaping processing on the generated text, identify an empathetic response portion and an action plan portion, and reconstruct the generated text as structured response data,
write the structured response data into the storage device in association with the dialogue data and store the structured response data as new dialogue history for reference in subsequent prompt sentence generation,
perform display control and audio output control to output the structured response data as character information on the display device or to convert the structured response data into voice information by using a speech synthesis program and output the voice information from an acoustic output device, and
receive, in response to a user operation, setting information specifying dialogue interface characteristics including at least one of an appearance display of artificial intelligence, color, character size, voice synthesis speaker profile, and speaking rate, and reflect the setting information in subsequent response generation and output format.

### (Supplementary 2)

The system according to supplementary 1,
wherein the processor is configured to
select a predetermined number of utterance units from the past dialogue history information of the user, perform length control processing for summarizing or truncating the past dialogue history information on the basis of an allowable token length of the generative AI model, and include the summarized or truncated past dialogue history information in the prompt sentence.

### (Supplementary 3)

The system according to supplementary 1,
wherein the processor is configured to
reconstruct the generated text as the structured response data by executing rule processing that adjusts at least one of a degree of use of technical terms, a level of detail of explanation, a difficulty level of the action plan, and an implementation period, in accordance with the user attribute information and the skill information, and generate response information including an action proposal adapted to an ability level and a situation of the user.

### Application Example 1

### (Supplementary 1)

A system comprising a processor,
wherein the processor is configured to
provide, on a terminal, a user interface for acquiring information from a user via character input or voice input, and to receive the information from the terminal via a communication line,
analyze the received information by using general-purpose software for natural language processing to perform morphological analysis, syntactic analysis, and semantic analysis,
generate structured data indicating a security-related target of interest, a risk factor, and an emotional state of the user, and, on the basis of attribute information and behavior history information of the user stored in a storage device, calculate feature values representing characteristics, skill level, and safety behavior pattern of the user,
generate a user profile including a current situation, a past behavior history, and the emotional state of the user on the basis of the structured data and the feature values, and create a prompt sentence by combining the user profile, an original input sentence from the user, and an instruction sentence defining a response policy for a generative AI model,
input the prompt sentence to the generative AI model operating on a general-purpose information processing apparatus or to an external service providing a generative AI model, and cause the generative AI model to generate a response sentence including feedback and a personalized action plan for reducing a security risk of the user,
perform formatting of an expression form, removal of prohibited expressions, and adjustment of an explanation level on the generated response sentence, generate audio data by using software for speech synthesis when necessary, and transmit a result to the terminal so that the result is presented visually or auditorily, and
acquire, from the terminal, operation content performed by the user on the basis of the feedback or the action plan, store the operation content as the behavior history information in the storage device, and reflect the stored behavior history information in generation of the prompt sentence in a subsequent processing.

### (Supplementary 2)

The system according to supplementary 1,
wherein the processor is configured to
add, to the prompt sentence, instructions for specifying a step-by-step action guideline, a degree of specialization of an explanation, and a tone, on the basis of a security literacy level and the behavior history information included in the user profile, and to instruct the generative AI model to generate an advice sentence and an action plan adapted to the user.

### (Supplementary 3)

The system according to supplementary 1,
wherein the processor is configured to
extract, from the information from the user, a security-related keyword and context information to classify a domain of interest and a type of risk, calculate an index indicating the emotional state of the user, and include, in the prompt sentence, instructions for adjusting an order of presenting information and a degree of expression strength in accordance with the index indicating the emotional state.

### Example 2

### (Supplementary 1)

A system comprising a processor,
wherein the processor is configured to
provide, to a terminal device, an interactive screen for receiving, from a user, visual elements and auditory elements for an information processing apparatus; and
analyze information including the visual elements and the auditory elements received from the user, and store the analyzed information as user-specific setting information in a storage device; and
generate a prompt sentence for a generative AI model, the prompt sentence being configured to instruct the generative AI model to (i) evaluate characteristics and an emotional state of the user based on the user-specific setting information and input information from the user, and
(ii) generate the visual elements and the auditory elements of the information processing apparatus based on the user-specific setting information; and
input the prompt sentence to the generative AI model, and obtain, from the generative AI model, visual element data and auditory element data of the information processing apparatus corresponding to the user-specific setting information, and data relating to feedback or a personalized action plan for the user; and
control display and audio output on the terminal device so as to display an appearance of the information processing apparatus based on the obtained visual element data and to reproduce a voice of the information processing apparatus based on the obtained auditory element data.

### (Supplementary 2)

The system according to supplementary 1,
wherein the processor is configured to
accumulate, as the user-specific setting information, past dialogue history of the user and information provided by the user, and generate the prompt sentence so as to instruct the generative AI model to propose the feedback or the action plan for the user based on the past dialogue history and the information provided by the user.

### (Supplementary 3)

The system according to supplementary 1,
wherein the processor is configured to
generate the prompt sentence so as to change at least one of content and presentation order of the visual element data and the auditory element data generated by the generative AI model, based on the emotional state of the user, and to distribute information from the user to different processing paths or processing targets according to an analysis result of the emotional state.

### Application Example 2

### (Supplementary 1)

A system comprising a processor,
wherein the processor is configured to
provide, to an information input/output apparatus, a user interface for receiving information from a user,
analyze text data or voice data acquired from the user by natural language processing or emotion analysis to extract feature information representing characteristics and an emotional state of the user,
construct a prompt sentence for a generative AI model, the prompt sentence being configured to instruct the generative AI model to propose feedback or a personalized action plan to the user, based on the extracted feature information and a dialogue context of the user,
input the constructed prompt sentence into the generative AI model and generate, as feedback information, a response sentence obtained from the generative AI model,
manage customization settings for at least one of a visual expression and an audio expression corresponding to the feedback information, in accordance with appearance parameters and voice parameters received from the user, and generate, based on the customization settings, a visual expression and an audio expression of a virtual entity, and
output the visual expression and the audio expression of the virtual entity to the information input/output apparatus and present the feedback information to the user through the virtual entity.

### (Supplementary 2)

The System According to Supplementary 1,
wherein the processor is configured to generate the prompt sentence by acquiring, from a storage device, past dialogue history and user attribute information of the user, and by incorporating the past dialogue history and the user attribute information into the dialogue context so as to instruct the generative AI model to propose feedback or an action plan adapted to the user.

### (Supplementary 3)

The system according to supplementary 1,
wherein the processor is configured to calculate, in the analyzing, an index indicating the emotional state of the user, and to control at least one of a processing order and an output format of the feedback information based on the index indicating the emotional state, and, when necessary, to distribute the feedback information to another processing apparatus or another responsible department.

What is claimed is:

1. A system comprising:
a communication interface coupled to a packet-switched network; and
circuitry configured to:
receive, via the communication interface, input information from a terminal device, the input information comprising at least one of voice information and character information, and convert voice information into character information by executing a speech recognition process;
retrieve, based on user identification information associated with the input information, user attribute information, skill information, personality information, and past dialogue history information from a storage device, and integrate the input information and the retrieved information to generate context information;
generate, based on the context information, a prompt comprising at least a role instruction, the user attribute information, the past dialogue history information, and current input information, and input the prompt to a generative neural network model to cause the generative neural network model to generate response text comprising response information and individualized plan information;
perform content safety determination processing and format shaping processing on the response text, identify a response portion and a plan portion, and reconstruct the response text as structured response data; and
store the structured response data in the storage device in association with the input information as updated dialogue history, and transmit the structured response data to the terminal device via the packet-switched network.

2. The system according to claim 1, wherein the circuitry is further configured to generate dialogue data comprising the character information, the user identification information, and a timestamp, and to store the dialogue data in the storage device prior to retrieval of the user attribute information.

3. The system according to claim 2, wherein the context information comprises a concatenation of the dialogue data, the user attribute information, the skill information, the personality information, and a summary of the past dialogue history information generated by truncation or extraction of relevant segments.

4. The system according to claim 3, wherein the prompt is generated by executing character string manipulation processing that inserts the role instruction, the user attribute information, a condensed representation of the past dialogue history, and the current input information into predefined template positions.

5. The system according to claim 4, wherein the role instruction specifies behavioral constraints for the generative neural network model comprising tone parameters, response length limits, and content-domain restrictions.

6. The system according to claim 5, wherein the generative neural network model generates the response text by executing numerical operations comprising matrix operations and an attention mechanism across a plurality of transformer layers.

7. The system according to claim 1, wherein the content safety determination processing comprises applying a classification model to the response text to detect content categories exceeding safety thresholds, and wherein the circuitry regenerates the response text with modified prompt constraints when a safety threshold is exceeded.

8. The system according to claim 7, wherein the format shaping processing comprises parsing the response text to identify delimited sections, mapping the identified sections to the response portion and the plan portion, and formatting each portion according to a predetermined output schema.

9. The system according to claim 8, wherein the plan portion comprises a plurality of action items each having a description field, a priority field, and an estimated duration field.

10. The system according to claim 1, wherein the circuitry is further configured to perform emotion estimation processing on the input information to generate an emotional-state index, and to incorporate the emotional-state index into the context information for prompt generation.

11. The system according to claim 10, wherein the emotion estimation processing comprises applying a text classification model trained on labeled emotional-state examples to the character information to produce an emotion label and an intensity score.

12. The system according to claim 11, wherein the circuitry is further configured to prioritize processing of the input information based on the emotional-state index, wherein input information associated with an intensity score exceeding a threshold is assigned elevated processing priority.

13. The system according to claim 12, wherein the circuitry is further configured to route the input information to a designated processing queue based on the emotion label and the intensity score, and to transmit notification information to an additional terminal device associated with a specialist entity when the intensity score exceeds the threshold.

14. The system according to claim 1, wherein the circuitry is further configured to convert the structured response data into voice information by executing a speech synthesis process and to transmit the voice information to the terminal device for acoustic output.

15. The system according to claim 14, wherein the speech synthesis process comprises selecting voice parameters comprising pitch, speaking rate, and intonation pattern based on the emotional-state index to produce emotionally adaptive voice output.

16. The system according to claim 1, wherein the circuitry is further configured to receive setting information from the terminal device specifying dialogue interface characteristics comprising at least one of an appearance configuration, a color scheme, a character size, and a voice synthesis style, and to apply the setting information to subsequent output formatting.

17. The system according to claim 1, wherein the circuitry is further configured to calculate a closed-loop engagement metric based on a ratio of continued dialogue sessions to total initiated sessions, and to adjust prompt-generation parameters when the engagement metric falls below a threshold.

18. A system comprising:
a communication interface coupled to a packet-switched network; and
circuitry configured to:
receive input information comprising voice information and character information from a terminal device via the communication interface, convert the voice information into character information by speech recognition, and generate dialogue data with user identification information and a timestamp;
retrieve user attribute information, skill information, personality information, and past dialogue history from a storage device, integrate the retrieved information with the dialogue data to generate context information, and perform emotion estimation to generate an emotional-state index;
generate a prompt by inserting a role instruction, the user attribute information, a condensed dialogue history, the emotional-state index, and current input into template positions, and input the prompt to a generative neural network model to obtain response text comprising a response portion and a plan portion with action items;
perform content safety determination using a classification model, regenerate with modified constraints when safety thresholds are exceeded, and format the response text into structured response data;
store the structured response data as updated dialogue history in the storage device, transmit the structured response data to the terminal device, and convert the structured response data to voice output via speech synthesis with voice parameters selected based on the emotional-state index; and
prioritize processing based on the emotional-state index and route input information to designated processing queues when the intensity score exceeds a threshold.

19. The system according to claim 18, wherein the circuitry is further configured to receive setting information from the terminal device specifying dialogue interface characteristics and to apply the settings to subsequent output formatting and voice synthesis parameters.

20. A method comprising:
receiving, by circuitry coupled to a packet-switched network, input information from a terminal device comprising at least one of voice information and character information, and converting voice information into character information;
retrieving user attribute information and past dialogue history from a storage device, and integrating the retrieved information with the input information to generate context information;
generating a prompt comprising a role instruction, the user attribute information, the dialogue history, and current input, and inputting the prompt to a generative neural network model to generate response text comprising response information and plan information;
performing content safety determination and format shaping on the response text to produce structured response data; and
storing the structured response data as updated dialogue history and transmitting the structured response data to the terminal device via the packet-switched network.
